(19) United States
(12) Patent Application Publication
(10) Pub. No.: US 2010/0166909 A1
(43) Pub. Date: Jul. 1, 2010

(54) Mold clamping mechanism and injection-molding method

(75) Inventors: Toshihiko Mizutani, Aichi-ken (JP); Munehiro Takagi, Aichi-ken (JP); Mineo Hayakawa, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/654,473

(22) Filed: Dec. 22, 2009

(30) Foreign Application Priority Data
Dec. 25, 2008 (JP) 2008-331516

(51) Int. Cl. B29C 45/64

(52) U.S. Cl. 425/595

(57) ABSTRACT

It is an object of the present invention to provide a mold clamping mechanism and an injection-molding machine that use a structure eliminating a die plate for clamping a mold to realize a compact structure and can shorten a molding cycle of a resin molded product by carrying out a mold clamping operation and an operation for releasing the mold clamping operation at higher speed.

### BACKGROUND OF THE INVENTION

1. Field of the invention

The present invention relates to a mold clamping mechanism that clamps a pair of molds under a high pressure in a resin molding and an injection-molding machine using the mold clamping mechanism.

2. Description of the Related Art

In an injection-molding machine, a mold clamping mechanism is provided which clamps a mold so that the mold is not opened by the injection pressure of a molten resin in the mold during a period until the molten resin is solidified after an injection is started. As the mold clamping mechanism, for instance, a structure disclosed in patent literature 1 is known. As shown in FIG. 14, in this mold clamping mechanism 200, at four corners (only two corners are shown in FIG. 14) of a fixed die plate 202 to which a fixed mold 201 is attached, ball screws 203 are supported so as to freely rotate through bearings 204. To the side surface of the fixed die plate 202 opposite to the fixed mold 201, the same number of motors 206 as that of the ball screws 203 are attached through brackets 205. To output shafts 207 of the motors 206, the corresponding ball screws 203 are driven and connected through joints 208. Further, to four corners (only two corners are shown in FIG. 14) of a movable die plate 209 provided in an opposite side of the fixed die plate 202 to the motors 206, the same number of ball nuts 210 as that of the ball screws 203 are fitted. To these ball nuts 210, end parts of the respectively corresponding ball screws 203 in the opposite sides to the motors 206 are screwed. To the side surface of the movable die plate 209 in the fixed mold 201 side, a movable mold 211 is attached. Accordingly, in the mold clamping mechanism 200, when the ball screws 203 are normally and reversely rotated and driven by the motors 206, the movable die plate 209 is reciprocated in the axial directions of the ball screws 203 and the movable mold 211 comes into contact with and is separated from the fixed mold 201 together with the movable die plate 209. During the resin molding, the movable mold 211 that is allowed to come into contact with the fixed mold 201 is further pressed to the fixed mold 201 through the rotation of the ball screws 203.

However, in the mold clamping mechanism 200 disclosed in the patent literature 1, in order to press the movable mold 211 to the fixed mold 201, the fixed die plate 202 and the movable die plate 209 are used separately from these molds. Namely, the fixed mold 201 is attached to the fixed die plate 202 and the movable mold 211 is attached to the movable die plate 209. Then, the positional relations of the ball screws 203 relative to the ball nuts 210 are changed to move the movable die plate 209 and thus press the movable mold 211 to the fixed mold 201. As described above, since various parts are used as well as the fixed mold 201 and the movable mold 211 as direct objects to be pressed, the mold clamping mechanism 200 is large. Further, since the heavy movable die plate 209 is moved to move the movable mold 211, the motors 206 of larger output torque are necessary, which causes the mold clamping mechanism 200 to be enlarged.

Thus, in order to solve the above-described enlargement of the mold clamping mechanism, the applicant of the present invention previously proposes, for instance, a mold clamping mechanism disclosed in patent literature 2. As shown in FIG. 15, the mold clamping mechanism 220 is provided in a side surface of a movable mold 221 opposite to a fixed mold 222. To an output shaft 224 of an electric motor 223 as a driving source of the mold clamping mechanism 220, a bolt 225 is operatively connected. The bolt 225 is inserted into a through hole 226 formed along the moving direction of the movable mold 221. Then, when the bolt 225 is rotated by driving the electric motor 223 under a state that the movable mold 221 is allowed to come into contact with the fixed mold 222 to carry out an injection-molding, a male screw formed in an end part of the bolt 225 is screwed into a female screw of a nut 227 provided in the fixed mold 222. Thus, the movable mold 221 is pressed to the fixed mold 222. In such a way, the bolt 225 is fastened, so that the movable mold 221 is directly pressed to the fixed mold 222. Accordingly, since the fixed die plate 202 and the movable die plate 209 for clamping the molds as shown in FIG. 14 are not necessary, the structure of the mold clamping mechanism is more compact than that of the mold clamping mechanism using the above-described members.

Patent literature 1: JP-A-5-269748

Patent literature 2: JP-A-2008-105391

As described above, the mold clamping mechanism disclosed in the patent literature 2 is assuredly made to be more compact than the mold clamping mechanism disclosed in the patent literature 1 which uses the fixed die plate and the movable die plate. However, in the mold clamping mechanism disclosed in the patent literature 2, there is room for improvement in respect of below-described points. Namely, in recent years, in order to improve the productive efficiency of resin products, a molding cycle of the injection-molding machine is still requested to be shortened. The molding cycle of the injection-molding machine receives at least slightly an influence of a mold clamping time by the mold clamping mechanism, that is, a time required until a mold claming force by the operation of the mold clamping mechanism is exhibited after the movable mold is allowed to come into contact with the fixed mold. Further, when the molding process of a resin is completed, and then, a molded product is taken out, since an operation is carried out in which a mold clamping state by the mold clamping mechanism is released to separate the movable mold from the fixed mold, namely, a mold opening operation is carried out, how quickly the mold clamping state is shifted to the mold opening operation also gives an influence to the molding cycle of the injection-molding machine. Therefore, the mold clamping mechanism is requested to switch the mold clamping state and a state in which the mold clamping state is released at higher speed.

In, this respect, in the mold clamping mechanism disclosed in the patent literature 2, the end part of the bolt 225 is screwed to the nut 227 of the fixed mold 222 side as described above to press the movable mold 221 to the fixed mold 222 and obtain the mold clamping state. Accordingly, during a mold clamping operation, the bolt 225 needs to be screwed into the nut 227 to a prescribed depth by driving the electric motor 223. Further, when the mold opening operation is carried out after the molding process of the resin is completed, the bolt 225 is rotated to be unfastened from the nut 227 to release the mold clamping state by driving the electric motor 223, and further, the bolt 225 needs to be detached from the nut 227.

In order to switch a mold clamping operation and an operation for releasing the mold clamping operation, that is, the mold clamping state and the state in which the mold clamping state is released at higher speed, for instance, the rotating speed of the electric motor 223 is supposed to be increased so as to shorten a time necessary for fastening the bolt 225 to the nut 227 or a time necessary for detaching the bolt 225 from the nut 227. However, even when the above-described method is used, since the structure is employed in which the bolt 225 is fastened to the nut 227 during the mold clamping operation, it is naturally limited to shorten a time for fastening the bolt 225 to the nut 227 and a time for detaching the bolt 225 from the nut 227. As described above, in the mold clamping mechanism disclosed in the patent literature 2, while the mold clamping mechanism is made to be compact by avoiding the use of the fixed die plate 202 and the movable die plate 209 shown in FIG. 14, there is room for improvement in view of a point as to how the mold clamping operation and the operation for releasing the mold clamping operation are realized at higher speed.

### SUMMARY OF THE INVENTION

The present invention is proposed to solve the above-described problems and it is an object of the present invention to provide a mold clamping mechanism and an injection-molding machine that use a structure eliminating a die plate for clamping a mold to realize a compact structure and can shorten a molding cycle of a resin molded product by carrying out a mold clamping operation and an operation for releasing the mold clamping operation at higher speed.

A first aspect of the invention provides with a mold clamping mechanism applied to an injection-molding machine that injects a molten resin into a space part formed between a fixed mold and a movable mold which is allowed to come into contact with and separate from the fixed mold when the movable mold is allowed to come into contact with the fixed mold to form a molded product, and pressing to the fixed mold the movable mold that is allowed to come into contact with the fixed mold in a resin molding, the mold clamping mechanism comprising: a shaft passing through the movable mold in its moving direction; a first actuator operatively connected to the shaft to apply a rotating force to the shaft; and a second actuator operatively connected to the shaft to apply a force in an opposite direction to the fixed mold to the shaft, wherein in an end part of the shaft in the fixed mold side, an engaging part is provided that is inserted into an inserting part provided in the fixed mold side as the movable mold is allowed to gradually come into contact with the fixed mold and is engaged with a part to be engaged which is provided in the inserting part when the shaft is rotated by a predetermined rotating angle through the operation of the first actuator under a state that the engaging part is inserted into the inserting part to regulate a displacement of the shaft in the opposite direction to the fixed mold, and under a state that the engaging part is engaged with the part to be engaged, the force is applied to the shaft in the opposite direction to the fixed mold through the operation of the second actuator to press the movable mold to the fixed mold.

According to the present invention, in the resin molding, when the movable mold is allowed to come into contact with the fixed mold, as the movable mold gradually comes into contact with the fixed mold, the engaging part formed in the end part of the shaft is inserted into the inserting part provided in the fixed mold side. Then, under the state that the engaging part of the shaft is inserted into the inserting part of the fixed mold, when the shaft is rotated by the predetermined rotating angle through the operation of the first actuator, the engaging part of the shaft is engaged with the part to be engaged which is provided in the inserting part in the fixed mold side. Thus, the displacement of the shaft in the opposite direction to the fixed mold, that is, a direction for drawing the shaft from the inserting part is regulated. Then, under the state that the engaging part of the shaft is engaged with the part to be engaged in the fixed mold side, when a force in the opposite direction to the fixed mold is applied to the shaft through the operation of the second actuator, that is, a force in the drawing direction of the shaft relative to the inserting part is applied to the shaft, the shaft elongates in the axial direction. As a result, in the shaft, tensile force for returning the shaft to an original state against the elongation, that is, an axial force is generated. The movable mold is pressed to the fixed mold by the axial force generated in the shaft to clamp the molds.

As described above, under the state that the end part of the shaft in the fixed mod side is connected to the fixed mold, the shaft is urged to separate from the fixed mold through the operation of the second actuator, so that the movable mold is directly pressed to the fixed mold. As described above, usually, the mold clamping mechanism is known in which in order to press the movable mold to the fixed mold, the fixed die plate to which the fixed mold is attached and the movable die plate to which the movable mold is attached are provided separately from the molds, and the ball screw passing through and supported by the movable die plate is screwed to the fixed die plate to press the movable mold to the fixed mold. In the mold clamping mechanism according to the present invention, since the movable mold is directly pressed to the fixed mold without using the fixed die plate and the movable die plate, which is different from the usual mold clamping mechanism, the fixed die plate and the movable die plate can be saved so that the mold clamping mechanism may be the more compact.

Further, as already described above, usually, the mold clamping mechanism is also known in which under the state that the movable mold is allowed to come into contact with the fixed mold, the end part (the end part in the fixed mold side) of the bolt passing through the movable mold is screwed to the female screw part of the fixed mold side to generate an axial force in the shaft part of the bolt so that the movable mold is pressed to the fixed mold. In the present invention, when the shaft is connected to the fixed mold, since the shaft does not need to take a plurality of turns, which is different from the usual mold clamping mechanism, a mold clamping operation is the simpler. Further, in the usual mold clamping mechanism, when the movable mold is separated from the fixed mold, the bolt needs to take a plurality of turns in the direction for unfastening the bolt to release the fixed state of the bolt to the fixed mold. However, according to the present invention, such an operation is not necessary. Therefore, a mold clamping operation and an operation for releasing the mold clamping operation can be carried out at high speed.

Accordingly, the mold clamping mechanism uses the structure eliminating the die plate for clamping the mold to realize the compact structure and can improve the molding cycle of a resin molded product by carrying out the mold clamping operation and the operation for releasing the mold clamping operation at higher speed.

A second aspect of the invention provides with the mold clamping machine, wherein the shaft is supported under a state that an amount of displacement of the shaft in its moving direction relative to the movable mold is regulated within a prescribed range, further, in the inserting part, an abutting part is provided on which an end face of the shaft in the fixed mold side abuts under the state that the movable mold is allowed to come into contact with the fixed mold, further, the second actuator may apply a force directed toward the fixed mold side to the shaft, and under a state that the application of the force toward the direction opposite to the fixed mold to the shaft through the operation of the second actuator is released and the engagement of the engaging part of the shaft with the part to be engaged of the inserting part side through the operation of the first actuator is released, the force directed toward the fixed mold side is applied to the shaft through the operation of the second actuator to separate the movable from the fixed mold.

According to the present invention, when the force directed toward the fixed mold side is applied to the shaft through the operation of the second actuator, the shaft is liable to be displaced toward the fixed mold side. However, under the state that the movable mold comes into contact with the fixed mold, the end face of the shaft in the fixed mold side is kept in a state that the end face abuts on the abutting part provided in the inserting part. Thus, the displacement of the shaft toward the fixed mold side is regulated due to the abutment of the end face in the fixed mold side on the abutting part. Accordingly, the shaft is compressed by the force directed toward the fixed mold side applied through the operation of the second actuator. Then, in the shaft, a repulsive force is generated for returning the shaft to its original state. Here, since the shaft is supported under the state that the amount of displacement of the shaft in its moving direction relative to the movable mold is regulated within a prescribed range, the repulsive force generated in the shaft is applied on the movable mold as a force in the direction for separating from the fixed mold. As a result, when the force directed toward the fixed mold side is applied to the shaft through the operation of the second actuator, the movable mold is separated from the fixed mold by the same distance as a distance by which the shaft is naturally displaced toward the fixed mold side. In such a way, the mold clamping mechanism also functions as a mold releasing mechanism for separating the movable mold from the fixed mold. Thus, the structure of an injection-molding machine is simplified differently from a case that the mold releasing mechanism is separately provided. Further, the mold clamping operation, the releasing operation of the mold clamping operation and a mold releasing operation can be continuously carried out through the mold clamping mechanism, which contributes to the improvement of the molding cycle of the resin molded product.

A third aspect of the invention provides with the mold clamping machine, wherein the second actuator includes a cylinder fixed to the movable mold and a piston externally fitted and fixed to the shaft, accommodated in an inner part of the cylinder and displaced within a prescribed range along the moving direction of the movable mold relative to the cylinder, under the state that the movable mold is allowed to contact with the fixed mold, a mold clamping fluid pressure or hydraulic pressure chamber is defined and formed in the fixed mold side of the piston in the cylinder and a mold releasing fluid pressure or hydraulic pressure chamber is defined and formed in a side of the piston opposite to the fixed mold by the piston, and when the force is applied to the shaft in the direction opposite to the fixed mold, a working fluid is supplied to the mold claming fluid pressure or hydraulic pressure chamber and when the force directed toward the fixed mold side is applied to the shaft, the working fluid is supplied to the mold releasing fluid pressure or hydraulic pressure chamber.

According to the present invention, when the movable mold is pressed to the fixed mold, under the state that the engaging part of the shaft is engaged with the part to be engaged in the fixed mold side through the operation of the first actuator, the working fluid is supplied to the mold clamping hydraulic pressure chamber in the cylinder. The pressure of the working fluid acts on the piston in the direction for separating the piston from the fixed mold. Then, since the piston is externally fitted and fixed to the shaft, the force in the direction opposite to the fixed mold is applied to the shaft through the piston. On the other hand, when the movable mold pressed to the fixed mold is separated from the fixed mold, under the state that the engaged state of the engaging part of the shaft with the part to be engaged in the fixed mold side is released through the operation of the first actuator, the working fluid is supplied to the mold releasing hydraulic pressure chamber in the cylinder. Thus, the force directed toward the fixed mold side is applied to the shaft through the piston. As described above, when the mold clamping operation for pressing the movable mold to the fixed mold or the mold releasing operation for separating the movable mold pressed to the fixed mold from the fixed mold is carried out, the working fluid is merely supplied to the mold clamping hydraulic pressure chamber or the mold releasing hydraulic pressure chamber in the cylinder, so that the force in the opposite direction to the fixed mold or in the direction toward the fixed mold side may be applied to the shaft to generate a prescribed axial force. Namely, the two forces directed in opposite directions to each other may be properly applied to the shaft by a simple structure such as the cylinder and the piston. Since such a structure is employed as the second actuator, the structure of the mold clamping mechanism is not complicated and may function as a mold releasing mechanism.

A fourth aspect of this invention provides with the mold clamping mechanism, wherein the engaging part of the shaft includes a plurality of engaging crests formed at prescribed intervals in its circumferential direction on an outer peripheral surface of the end part of the shaft in the fixed mold side and formed with a prescribed length at prescribed intervals in the axial direction of the shaft and along the circumferential direction of the shaft, the inserting part is formed in the fixed mold as an inserting hole corresponding to the outer form of the end part of the shaft in the fixed mold side, the part to be engaged of the inserting part includes a plurality of engaging grooves formed at the same intervals as those of the engaging part of the shaft side in its circumferential direction on an inner peripheral surface of the inserting part and formed with a prescribed length at prescribed intervals in the axial direction of the inserting part and along the circumferential direction of the inserting part, the shaft is inserted into the inserting part in such a holding state as to arrange alternately the plurality of engaging parts and the parts to be engaged of the inserting part side in its rotating direction and under the state that the shaft is inserted into the inserting part, the shaft is rotated by an angle half the interval for forming the engaging part as the predetermined rotating angle through the operation of the first actuator so that the engaging crests forming the engaging part are respectively engaged with the engaging grooves respectively forming the part to be engaged to regulate the displacement of the shaft in the direction opposite to the fixed mold.

When the present invention is applied to the invention defined in the first aspect of the invention, below-described operational effects are obtained. Namely, in the mold clamping operation, as the movable mold is allowed to gradually come into contact with the fixed mold, the shaft is inserted into the inserting part in such a holding state as to arrange alternately the plurality of engaging parts and the parts to be engaged of the fixed mold side in its rotating direction. In other words, in a positional relation that the engaging parts of the shaft side and the parts to be engaged in the fixed mold side are alternately arranged, when the shaft is inserted into the inserting part, the plurality of engaging crests forming the engaging parts in the shaft side do not interfere with the plurality of engaging grooves forming the parts to be engaged in the inserting part side.

Thus, the shaft can be smoothly inserted into the inserting part. Then, under the state that the engaging part of the shaft is inserted into the inserting part of the fixed mold side, the shaft is rotated by an angle half the interval for forming the engaging part as the predetermined rotating angle through the operation of the first actuator so that the engaging crests forming the engaging part are respectively engaged with the engaging grooves respectively forming the part to be engaged. Thus, the displacement of the shaft in the direction opposite to the fixed mold is regulated. As described above, as the movable mold gradually comes into contact with the fixed mold, the shaft is inserted into the inserting part in the fixed mold side. Further, the shaft can be connected to the fixed mold only by slightly rotating the inserted shaft. After that, the force in the direction opposite to the fixed mold is applied to the shaft through the operation of the second actuator to press the movable mold to the fixed mold. Accordingly, in the mold clamping operation, a connecting operation of the shaft to the fixed mold is carried out more rapidly than, for instance, a case that the shaft is screwed into the fixed mold until the shaft reaches to a prescribed depth. Thus, the mold clamping operation is carried out at high speed.

Further, when the present invention is applied to the invention defined in the second aspect of the invention, in the mold releasing operation, the connected state of the shaft and the fixed mold is released only by slightly rotating the shaft in the direction opposite to that in the case of the mold clamping operation. Specifically, since the engaging parts of the shaft side and the parts to be engaged in the fixed mold side are alternately arranged, the shaft can be drawn from the inserting part of the fixed mold side, and accordingly, the movable mold can be moved in the direction for separating from the fixed mold. Accordingly, in the mold releasing operation for separating the movable mold from the fixed mold, a releasing operation of the connection of the shaft to the fixed mold is carried out more rapidly than the case that in the mold clamping operation, the shaft is screwed into the fixed mold until the shaft reaches to a prescribed depth as described above. Thus, the molding cycle of an injection-molding machine is shortened.

Further, when the present invention is applied to the invention defined in the third aspect of the invention, are obtained the same operational effects as those obtained when the present invention is applied to the invention defined in the first aspect of the invention.

The invention defined in a fifth aspect of the invention concerns a mold clamping mechanism according to the first aspect of the invention, wherein the first actuator is a hydraulic pressure motor having an output shaft rotating in accordance with the hydraulic pressure of the working fluid supplied from an external part.

As the first actuator for applying the rotating force to the shaft in the present invention, for instance, the hydraulic pressure motor may be used.

A sixth aspect of the invention concerns an injection-molding machine that forms a space part between a fixed mold and a movable mold which is allowed to come into contact with or separate from the fixed mold by allowing the movable mold to come into contact with the fixed mold, presses the movable mold to the fixed mold to clamp the molds through the operation of a mold clamping mechanism and injects a molten resin into the space part under a mold clamped state to form a molded product, the injection-molding machine including the mold clamping mechanism according to the first aspect of the invention as the mold clamping mechanism.

According to the present invention, the injection-molding machine can be provided that has the operational effects by the mold clamping mechanism according to the first aspect of the invention. Especially, since the mold clamping operation can be carried out at high speed, the molding cycle of the injection-molding machine is shortened.

According to the present invention, the structure eliminating a die plate for clamping a mold is used to realize a compact structure and the molding cycle of a resin molded product can be shortened by carrying out the mold clamping operation and the releasing operation of the mold clamping operation at higher speed.

### BRIEF DESCRIPTION OF THE DRAWINGS

FIG. 1 is a longitudinally sectional view of an injection-molding machine with a part omitted.

FIG. 2 is a longitudinally sectional view of a main part of a mold clamping mechanism.

FIG. 3 is a sectional view taken along a line 1-1 of FIG. 2.

FIG. 4(a) and FIG. 4(b) are front views showing the end part of a shaft and FIG. 4(c) is a side view of a member to be engaged that is seen from an inserting side of the shaft.

FIG. 5 is a perspective view of the shaft and the member to be engaged.

FIG. 6(a) is a longitudinally sectional view of the main parts of the shaft and the member to be engaged and FIG. 6(b) is a side view of the member to be engaged that is seen from the inserting side of the shaft.

FIG. 7(a) is a longitudinally sectional view of main parts showing an inserted state of the shaft to the member to be engaged and FIG. 7(b) is a longitudinally sectional view of main parts showing an engaged state of the shaft to the member to be engaged.

FIG. 8 is a sectional view taken along a line 2-2 of FIG. 7(a) and FIG. 8(b) is a sectional view taken along a line 3-3 of FIG. 7(b).

FIG. 9 is a longitudinally sectional view of the mold clamping mechanism in a mold opening state.

FIG. 10 is a longitudinally sectional view of the mold clamping mechanism in a mold closing state.

FIG. 11 is a longitudinally sectional view of the mold clamping mechanism in a mold clamping state.

FIG. 12 is a longitudinally sectional view of the mold clamping mechanism in a mold releasing state.

FIG. 13 is a longitudinally sectional view of main parts showing a state that a spacer is arranged in other exemplary embodiment.

FIG. 14 is a front view showing a usual mold clamping mechanism.

FIG. 15 is a front view showing a usual mold clamping mechanism.

### DESCRIPTION OF THE PREFERRED EMBODIMENTS

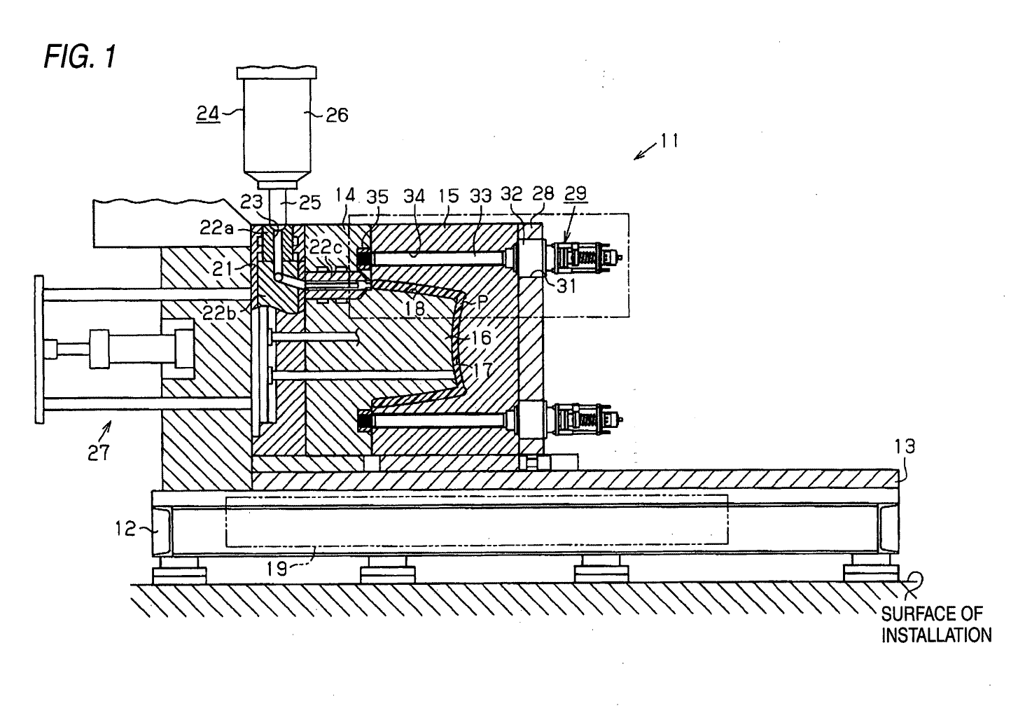

Now, a first exemplary embodiment obtained by embodying the present invention as a mold clamping mechanism of a horizontal injection-molding machine will be described below by referring to FIG. 1.

### <Entire Structure of Injection-Molding Machine>

As shown in FIG. 1, on an upper surface of a base 12 of an injection-molding machine 11, a bush 13 is provided. To the upper surface of the bush 13, a fixed mold 14 is fixed. Further, on the surface of the bush 13, a movable mold 15 is provided so as to slide in the directions (rightward and leftward in FIG. 1) for allowing the movable mold 15 to come into contact with and separate from the fixed mold 14. On a side surface of the fixed mold 14 in the movable mold 15, a molding protrusion 16 is provided. On a side surface of the movable mold 15 in the fixed mod 14 side, a molding recessed part 17 is provided. Then, under a state that the movable mold 15 is allowed to come into contact with the fixed mold 14, the molding protrusion 16 enters the molding recessed part 17 to form a cavity 18 as a space for forming a resin molded product P between them.

In a lower part of the injection-molding machine 11, an opening and closing mechanism 19 operatively connected to the movable mold 15 is provided. The opening and closing mechanism 19 allows the movable mold 15 to slide and move so as to come into contact with and separate from the fixed mold 14, namely, allows a pair of molds including the fixed mold 14 and the movable mold 15 to open and close. The movable mold 15 slides and moves so as to come into contact with and separate from the fixed mold 14 through the operation of the opening and closing mechanism 19. As the opening and closing mechanism 19, for instance, a hydraulic cylinder mechanism or an electric motor mechanism may be employed. The expansion movement of a plunger of a hydraulic cylinder is transmitted to the movable mold 15, or the rotating movement of an electric motor is converted into a movement of the movable mold 15 in the sliding direction and the converted movement is transmitted to the movable mold 15. Thus, the movable mold 15 slides and moves so as to come into contact with or separate from the fixed mold 14.

Further, in a part of the fixed mold 14 opposite to the movable mold 15 on the upper surface of the bush 13, a fixed plate 21 is provided. The fixed plate 21 comes into contact with a side surface of the fixed mold 14 opposite to the molding protrusion 16. In an upper part of the fixed plate 21, a first sprue bush 22a and a second sprue bush 22b are incorporated from an upper part. On the other hand, to a side surface of the fixed mold 14 in the fixed plate 21 side, a third sprue bush 22c is fitted so as to correspond to the second sprue bush 22b. In the first to third sprue bushes 22a to 22c, a sprue 23 serving as a passage for a molten resin as a molding material is continuously formed. One end of the sprue 23 is opened on the upper surface of the first sprue bush 22a. Similarly, the other end is opened on the side surface of the fixed mold 14 in the movable mold 15 side through the third sprue bush 22c. Namely, under the state that the movable mold 15 comes into contact with the fixed mold 14, the cavity 18 formed between them communicates with an external part through the sprue 23.

Further, in an upper part of the fixed plate 21, a vertical injection device 24 is provided. In the injection device 24, a screw not shown in the drawing is arranged in a heating cylinder 26 having a nozzle 25 in its lower end. In the injection device 24, the molten resin material is stored in a lower part of the heating cylinder 26. The molten resin material is injected downward under high pressure from the nozzle 25 through a forward movement of the screw. The injected molten resin is supplied to the cavity 18 through the sprue 23. When the molten resin is injected, an end part of the nozzle 25 is pressed to the upper surface of the first sprue bush 22a under the high pressure to ensure a sealing performance between the end part of the nozzle 25 and a peripheral edge part of an opening of the sprue 23 on the upper surface of the first sprue bush 22a.

Further, in a side of the fixed plate 21 opposite to the fixed mold 14, an ejector mechanism 27 is provided for ejecting the molded product P in close contact with the molding protrusion 16 from the molding protrusion 16 during a mold opening operation for separating the movable mold 15 from the fixed mold 14 to take out the molded product P between both the molds.

On the other hand, to a side of the movable mold 15 opposite to the fixed mold 14, a movable plate 28 is detachably attached. In the movable plate 28, a plurality of sets of mold clamping mechanisms 29 are provided. In a resin molding, the mold clamping mechanism 29 serves to press the movable mold 15 that is allowed to come into contact with the fixed mold 14 to the fixed mold 14 so that the mold clamping mechanism 29 clamps the molds not to separate the movable mold 15 from the fixed mold 14 by the injection pressure of the molten resin until the molten resin is cooled and solidified after the molten resin begins to be injected into the cavity 18. In FIG. 1, only a pair of mold clamping mechanisms 29 is shown that are arranged in upper and lower parts of the movable plate 28. However, actually, the plurality of sets of mold clamping mechanisms 29 is provided in directions orthogonal to a sheet surface. The mold clamping mechanisms 29 have the same structures.

### <Mold Clamping Mechanism>

Now, the mold clamping mechanism will be described below in detail.

As shown in FIG. 1, the mold clamping mechanism 29 includes a hydraulic washer 32 inserted into an accommodating hole 31 of the movable plate 28 and a shaft 33 inserted into and supported by the washer 32. The shaft 33 is provided in parallel with a moving direction of the movable mold 15 and inserted into a through hole 34 formed in the movable mold 15 in parallel with the moving direction of the movable mold 15. An end part of the shaft 33 protrudes from the side surface of the movable mold 15 in the fixed mold 14 side. The end part of the shaft 33 is inserted into a member 35 to be engaged that is opened in the side surface of the fixed mold 14 in the movable mold 15 side and engaged with the part 35 to be engaged.

An engaging structure of the end part of the shaft 33 and the member 35 to be engaged will be described below in detail.

### <Hydraulic Washer>

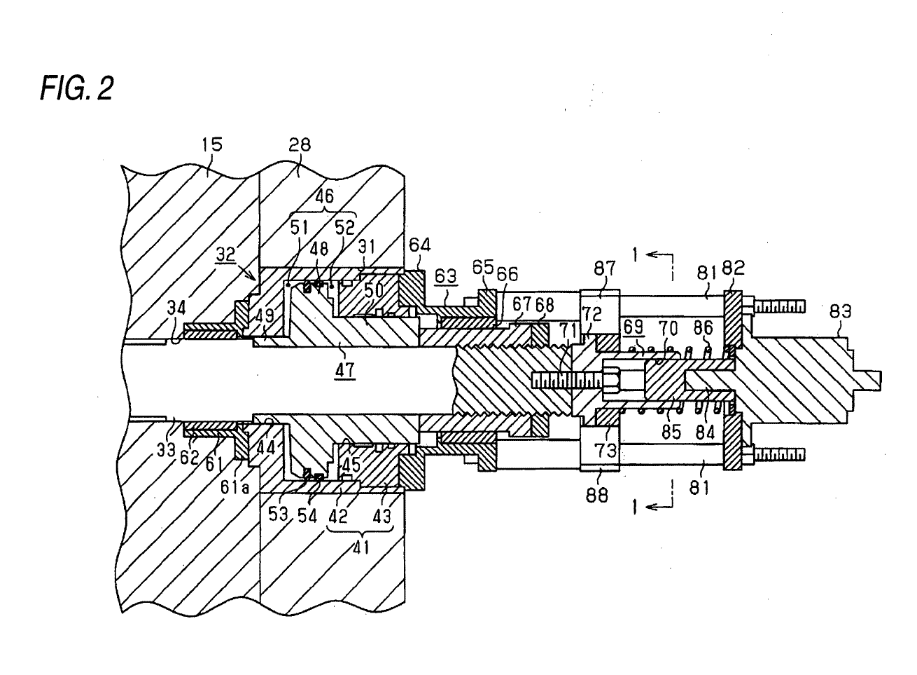

As shown in FIG. 2, a cylinder 41 of the hydraulic washer 32 is internally fitted to the accommodating hole 31 of the movable plate 28, and includes a cylinder main body 42 having a side surface opposite to the movable mold 15 opened and a tubular form with a bottom and a cover member 43 for closing the opening part of the cylinder main body 42. Though not shown in FIG. 2, an outer configuration of the cylinder main body 42 has a parallelepiped shape and an inside diameter form is configured in a cylindrical form. In the central part of a bottom wall of the cylinder main body 42, a first insert hole 44 is formed that has an inside diameter a little larger than the outside diameter of the shaft 33. Further, in a central part of the cover member 43, a second insert hole 45 is formed that has an inside diameter larger than the inside diameter of the first insert hole 44. The first and second insert holes 44 and 45 are coaxially provided. Then, the shaft 33 is inserted into the first and second insert holes 44 and 45.

An inner space formed by the cylinder main body 42 and the cover member 43 is a hydraulic chamber 46. In the hydraulic chamber 46, a piston 47 is accommodated under a state that the piston 47 is externally fitted to and fixed the shaft 33. The piston 47 includes a cylindrical piston main body 48 provided in the hydraulic chamber 46, a first cylindrical support part 49 protruding in a side surface of the piston main body 48 opposite to the cover member 43 and inserted into the first insert hole 44 of the cylinder main body 42 and a second cylindrical support part 50 protruding in a side surface of the piston main body 48 in the cover member 43 side and inserted into the second insert hole 45 of the cover member 43 which are integrally formed. The second support part 50 protrudes outside the cover member 43 through the second insert hole 45.

The first support part 49 reciprocates and slides on the inner peripheral surface of the first insert hole 44 in the axial direction of the first support part 49 and rotates and slides on its axis. Further, the second support part 50 reciprocates and slides on the inner peripheral surface of the second insert hole 45 in the axial direction of the second support part 50 and rotates and slides on its axis. Namely, the shaft 33 formed integrally with the piston 47 reciprocate to be displaced to the cylinder 41 in the axial direction thereof and rotates on an axis thereof.

In the hydraulic chamber 46, a mold clamping hydraulic chamber 51 to which a working fluid is supplied from an external part during a mold clamping operation and a mold releasing hydraulic chamber 52 to which the working fluid is supplied from the external part are defined by the piston main body 48. Namely, in the hydraulic chamber 46, a space opposite to the cover member 43 relative to the piston main body 48 is set as the mold clamping hydraulic chamber 51 and a space in the cover member 43 side is set as the mold releasing hydraulic chamber 52. To the mold clamping hydraulic chamber 51 and the mold releasing hydraulic chamber 52, the working fluid of high pressure is supplied through a sprue runner not shown in the drawing that is provided in the cylinder main body 42 and the movable plate 28.

When the working fluid of the high pressure is supplied to the mold clamping hydraulic chamber 51 through the sprue runner, the hydraulic pressure of the working fluid is applied to a side surface of the piston main body 48 in the mold clamping hydraulic chamber 51 side, so that the piston 47 is displaced to the cover member 43 side integrally with the shaft 33. On the other hand, when the working fluid of the high pressure is supplied to the mold releasing hydraulic chamber 52 through the sprue runner, the hydraulic pressure of the working fluid is applied to a side surface of the piston main body 48 in the mold releasing hydraulic chamber 52 side, so that the piston 47 is displaced to a side opposite to the cover member 43 together with the shaft 33.

To an outer peripheral surface of the piston main body 48, an O ring 53 and an oil seal 54 are attached as sealing devices for maintaining a liquid tightness between the mold clamping hydraulic chamber 51 and the mold releasing hydraulic chamber 52. The liquid tightness between the mold clamping hydraulic chamber 51 and the mold releasing hydraulic chamber 52 is ensured by the O ring 53 when the piston 47 is reciprocally displaced, and by the oil seal 54 when the piston 47 rotates. Further, through not shown in the drawing, between an outer peripheral surface of the first support part 49 and an inner peripheral surface of the first insert hole 44, and between an outer peripheral surface of the second support part 50 and an inner peripheral surface of the second insert hole 45, similar sealing devices are also provided. Thus, the liquid tightness of inner and outer parts of the hydraulic chamber 46 is ensured.

### <Structure of Hydraulic Washer in Mold Side>

As shown in FIG. 2, to a bottom surface of the cylinder main body 42, a cylindrical guide support member 61 inserted to the shaft 33 is fixed. More precisely, a bolt not shown in the drawing is inserted to an annular collar part 61a formed on a base end part of the guide support member 61 from an opposite side to the cylinder main body 42 and fastened to fix the guide support member 61 to the bottom surface of the cylinder main body 42. To the guide support member 61, a cylindrical shaft guide member 62 having both ends opened is internally fitted. Into the shaft guide member 62, the shaft 33 is inserted. The inside diameter of the shaft guide member 62 is set to a dimension slightly larger than that of the outside diameter of the shaft 33. Namely, the outer peripheral surface of the shaft 33 comes into sliding contact with the inner peripheral surface of the shaft guide member 62.

### <Structure of Hydraulic Washer Opposite to Mold>

On the other hand, as shown in FIG. 2, to a side surface of the hydraulic washer 32 opposite to the movable mold 15, a cylindrical support base 63 having both ends opened is attached. In an end part of the support base 63 in the hydraulic washer 32 side, a first rectangular plate shaped collar part 64 is formed which is fixed to the cover member 43. Further, in an end part of the support base 63 opposite to the hydraulic washer 32, a second rectangular plate shaped collar part 65 is formed.

To the support base 63, a cylindrical collar guide member 66 having both ends opened is internally fitted. Into the collar guide member 66, a cylindrical collar 67 screwed to an outer peripheral surface of the shaft 33 is inserted. The inside diameter of the collar guide member 66 is set to a dimension a little larger than that of the outside diameter of the collar 67. Namely, an outer peripheral surface of the collar 67 comes into sliding contact with an inner peripheral surface of the collar guide member 66. An end face of the collar 67 in the hydraulic washer 32 side is held under a state that the end face comes into contact with an end face of the second support part 50 of the piston 47 protruding from the cover member 43. Further, an end part of the collar 67 opposite to the hydraulic washer 32 protrudes outside from a side surface of the support base 63 opposite to the hydraulic washer 32. Then, to an end face of the collar 67 opposite to the hydraulic washer 32, an annular locking member 68 screwed to the shaft 33 is fixed by a bolt not shown in the drawing. Thus, the collar 67 screwed to the shaft 33 is locked.

The end part of the shaft 33 slightly protrudes outward from a side surface of the locking member 68 opposite to the hydraulic washer 32. To an end face of the protruding shaft 33, a cylindrical driven shaft 69 with a bottom is fixed which is opened to an opposite side to the hydraulic washer 32. Namely, in the driven shaft 69, a hexagonal post shaped hole 70 is formed which is opened to the opposite side to the hydraulic washer 32. A bolt 71 is inserted to a bottom wall of the driven shaft 69 through the opening of the hole 70 and fastened to fix the driven shaft 69 to the end face of the shaft 33. In an end face of the driven shaft 69 in the shaft 33 side, a flange 72 is formed. To a side surface of the flange 72 opposite to the shaft 33, a stopper 73 externally fitted to the driven shaft 69 is fixed by a bolt not shown in the drawing.

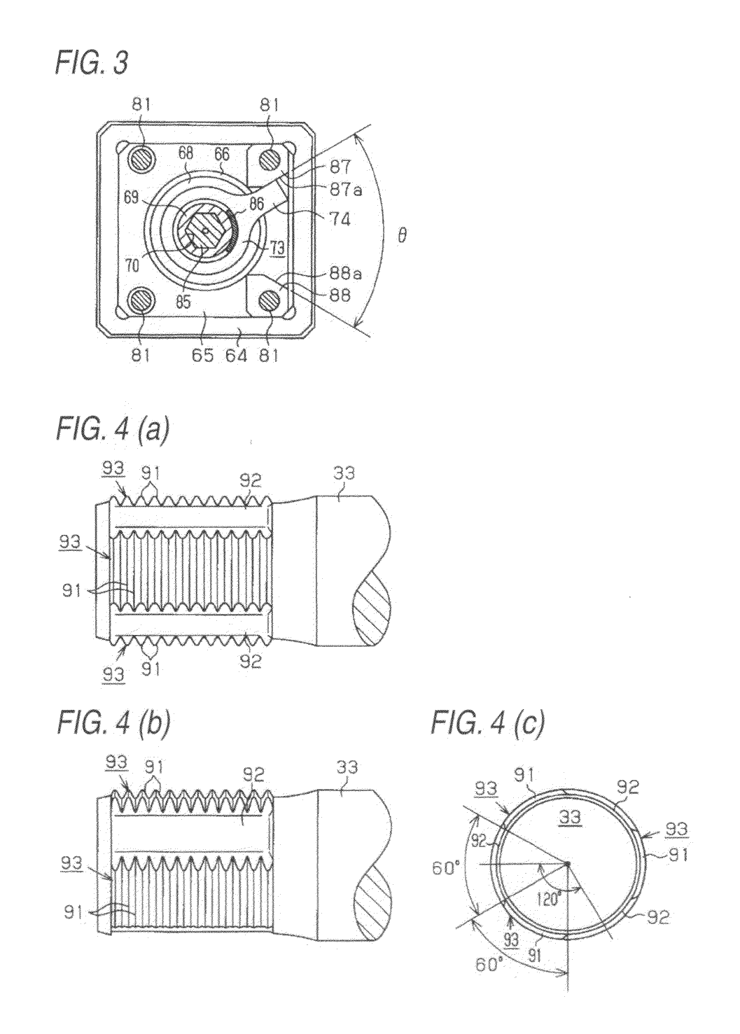

Accordingly, the stopper 73, the driven shaft 69, the locking member 68 and the collar 67 are displaced integrally with the shaft 33 together with the piston 47. As shown in FIG. 3, the stopper 73 is formed in an annular shape and includes a rectangular shaped engaging part 74 which protrudes to a side part thereof.

### <Power Transmitting Mechanism>

In addition, as shown in FIG. 3, at four corners of the second collar part 65 of the support base 63, four struts 81 are provided. As shown in FIG. 2, to ends of the struts 81 (the right ends in FIG. 2), rectangular plate shaped motor attaching members 82 are fixed. To side surfaces of the motor attaching members 82 opposite to the support base 63, an air motor 83 is fixed. The air motor 83 has an output shaft 84 rotating in accordance with the hydraulic pressure of the working fluid (here, compressed air) supplied from an external part. The output shaft 84 passes through the motor attaching members 82 toward the support base 63 side and is provided coaxially with the shaft 33.

To the output shaft 84 of the air motor 83, a driving shaft 85 is fixed. Also shown in FIG. 3, the driving shaft 85 is formed in a hexagonal post shape corresponding to the inner shape of the hole 70 of the driven shaft 69. Then, an end part of the driving shaft 85 is inserted into the hole 70. The driving shaft 85 is guided by the inner peripheral surface of the hole 70 to reciprocate and slide in the axial direction of the hole 70. The movement of the driving shaft 85 in the axial direction of the hole 70 is permitted by a gap formed between an inner end face of the driving shaft 85 and the bolt 71. Six exterior angles of the driving shaft 85 are engaged with six interior angles of the hole 70, so that the driving shaft 85 and the driven shaft 69 integrally rotate. Namely, the rotating movement of the output shaft 84 of the air motor 83 is transmitted to the shaft 33 through the driving shaft 85 and the driven shaft 69. Accordingly, when the output shaft 84 rotates through the operation of the air motor 83, the shaft 33 rotates in the same direction as that of the output shaft 84.

As shown in FIG. 2, a compression coil spring 86 is attached to the driven shaft 69 between the stopper 73 and the motor attaching members 82. The compression coil spring 86 is held in a slightly compressed state. Namely, the stopper 73, the driven shaft 69 and the shaft 33 are constantly urged to separate from the motor attaching members 82 (toward a left side in FIG. 2) by a resilient force of the compression coil spring 86. The piston 47 fixed to the shaft 33 is also constantly urged to separate from the motor attaching members 82 by the resilient force of the compression coil spring 86. Since, under a state that the working fluid is not supplied to the hydraulic chamber 46, the piston main body 48 abuts on the inner bottom surface of the cylinder main body 42, the displacement of the piston 47 toward the above-described direction is regulated.

Further, as shown in FIG. 2, to the two adjacent struts 81 of the four struts 81, first and second stopper abutting members 87 and 88 are fixed between the motor attaching members 82 and the locking member 68. The first and second stopper abutting members are provided correspondingly to the stopper 73 fixed to the driven shaft 69. Then, as shown in FIG. 3, in side surfaces of the first and second stopper abutting members 87 and 88 that are opposed to each other, engaging surface 87a and 88a are formed with which the engaging part 74 of the stopper 73 is engaged. Both the engaging surfaces 87a and 88a are formed so that the engaging surfaces 87a and 8a form a prescribed angle θ (an obtuse angle) when the stopper 73 is viewed from the axial direction of the driven shaft 69. Here, the angle A formed by the two engaging surfaces 87a and 88a is set 60°. Accordingly, the stopper 73 is rotated and displaced between a position where the engaging part 74 of the stopper 73 is engaged with the engaging surface 87a of the first stopper abutting member 87 and a position where the engaging part 74 is engaged with the engaging surface 88a of the second stopper abutting member 88. Namely, since the stopper 73 is rotated and displaced integrally with the shaft 33, the engaging part 74 of the stopper 73 is engaged with the first and second stopper abutting members 87 and 88, so that the rotation and displacement of the shaft 33 exceeding 60° is regulated. In other words, the rotation of the stopper 73, and the driven shaft 69 and the shaft 33 rotating integrally with the stopper 73 is permitted within a range of angle of 60°.

### <End Part of Shaft>

As shown in FIGS. 4(a) and 4(b), on an outer peripheral surface of an end part (a leading end part)of the shaft 33 in the fixed mold 14 side, a plurality of engaging parts 93 are provided at prescribed intervals in the circumferential direction of the shaft 33. The engaging parts 93 are formed with a plurality of engaging crests 91 at prescribed intervals in the axial direction of the shaft 33 and with a prescribed length along the circumferential direction of the shaft 33. The engaging parts 93 are formed, for instance, in such a manner as described below. Namely, on the outer peripheral surface of the end part of the shaft 33, many (here, 12) annular engaging crests 91 are formed at prescribed intervals in the axial direction of the shaft 33. Then, a plurality of circular arc surfaces 92 are formed at intervals of prescribed angles in the circumferential direction of the shaft 33 through a cutting work to form the engaging parts 93 composed of the plurality of engaging crests 91.

Here, as shown in FIG. 4(c), the circular arc surfaces 92 are formed at intervals of 120° in the circumferential direction of the shaft 33 to form three engaging parts 93. Further, the engaging parts 93 and the circular arc surfaces 92 are respectively formed within a range of angle of 60° in the circumferential direction of the shaft 33. In this case, as shown in FIG. 4(c), the three engaging parts 93 and the three circular arc surfaces 92 are respectively located in opposite sides to each other.

As shown in FIGS. 4(a) and 4(b), each engaging crest 91 is formed so as to have a triangular shape in section when the shaft 33 is cut on a virtual plane including the axis of the shaft 33. Further, as shown in FIGS. 4(a) and 4(b), the circular arc surfaces 92 are formed over an entire length of the part of the shaft 33 on which the engaging crests 91 are formed in the axial direction of the shaft 33. Further, as shown in FIG. 4(c), the three circular arc surfaces 92 are located on a virtual circumferential surface coaxial with the shaft 33 and having a diameter smaller than the outside diameter of the shaft 33. As shown in FIG. 4(c), the circular arc surfaces 92 are respectively connected to the engaging crests 91 through smooth curved surfaces.

### <Member to be Engaged>

As described above, since the end part of the shaft 33 is inserted into and engaged with the member 35 to be engaged that is provided in the fixed mold 14 side, now, the member 35 to be engaged will be described below.

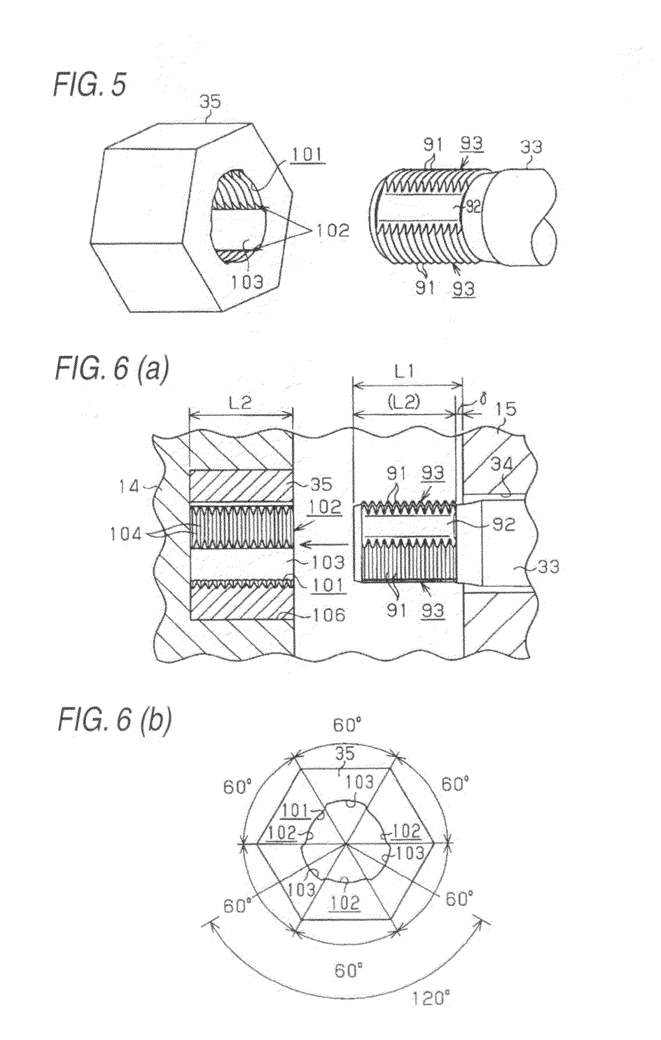

As shown in FIG. 5, the member 35 to be engaged is formed in a hexagonal post shape. In a central part of the member 35 to be engaged, an insert hole 101 is formed. In an inner peripheral surface of the insert hole 101, a plurality of parts 102 to be engaged are provided at prescribed intervals in the circumferential direction of the inner peripheral surface. As shown in FIG. 6(a), the parts 102 to be engaged are formed with a plurality of engaging grooves 104 at prescribed intervals in the axial direction of the insert hole 101 and with a prescribed length along the circumferential direction of the insert hole 101.

The parts 102 to be engaged are formed, for instance, in such a manner as described below. Namely, as shown in FIG. 6(a), on the inner peripheral surface of the insert hole 101, many (here, 12) annular engaging grooves 104 are formed at prescribed intervals in the axial direction of the insert hole 101. Then, a plurality of circular arc surfaces 103 are formed at intervals of prescribed angles in the circumferential direction of the insert hole 101 through a cutting work to form the parts 102 to be engaged that are composed of the plurality of engaging grooves 104. Here, as shown in FIG. 6(b), the circular arc surfaces 103 are formed at intervals of 120° in the circumferential direction of the insert hole 101 to form the three parts 102 to be engaged. Further, the parts 102 to be engaged and the circular arc surfaces 103 are respectively formed within a range of angle of 60° in the circumferential direction of the inner peripheral surface of the insert hole 101. In this case, in the inner peripheral surface of the insert hole 101, the three parts 102 to be engaged and the three circular arc surfaces 92 are respectively located in opposite sides to each other.

As shown in FIG. 6(a), each engaging groove 104 is formed so as to have a triangular shape in section when the member 35 to be engaged is cut on a virtual plane including the axis of the member 35 to be engaged. The inner forms of the engaging grooves 104 correspond to the outer forms of the engaging crests 91 of the shaft 33 side. Further, as shown in FIG. 6(a), the circular arc surfaces 103 are formed over an entire length of the part of the member 35 to be engaged on which the engaging grooves 104 are formed in the axial direction of the member 35 to be engaged. Further, as shown in FIG. 6(b), the three circular arc surfaces 103 are located on the same virtual circumferential surface coaxial with the insert hole 101 and having a diameter larger than the original inside diameter of the insert hole 101 before the circular arc surfaces 103 are formed. The depth of each engaging groove 104 is substantially equally set to the height of each engaging crest 91 to the outer peripheral surface of the shaft 33.

The member 35 to be engaged which is formed as described above is fitted and fixed to a recessed part 106 formed in a side surface of the fixed mold 14 in the movable mold 15 side as shown in FIG. 6(a). The side surface of the member 35 to be engaged in the movable mold 15 side has no stepped part relative to the side surface of the fixed mold 14 in the movable mold 15 side, that is, is flush with the side surface of the fixed mold. Accordingly, when the movable mold 15 is allowed to come into contact with the fixed mold 14, both the molds come into close contact with each other without forming a gap between the contact surfaces thereof.

<Engaging Structure of Shaft with Member to be Engaged>

Since the inner form of the insert hole 101 corresponds to the outer form of the end part of the shaft 33, under a state that the engaging parts 93 of the shaft 33 are allowed to correspond to the circular arc surfaces 103 of the member 35 to be engaged in a rotating direction, the end part of the shaft 33 can be smoothly inserted into the insert hole 101 of the member 35 to be engaged. Namely, the engaging parts 93 of the shaft 33 side correspond to the circular arc surfaces 103 of the member 35 to be engaged, and the circular arc surfaces 92 of the shaft 33 side correspond to the parts 102 to be engaged of the member 35 to be engaged respectively. Therefore, when the shaft 33 is inserted into the insert hole 101, the engaging parts 93 of the shaft 33 side do not interfere with the parts 102 to be engaged of the member 35 to be engaged.

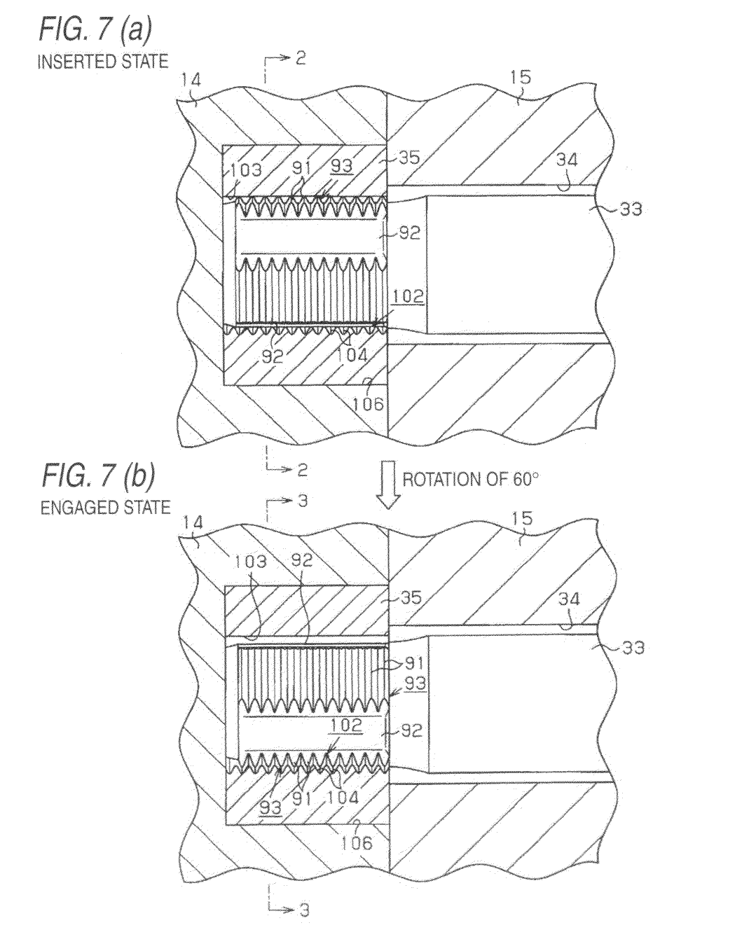

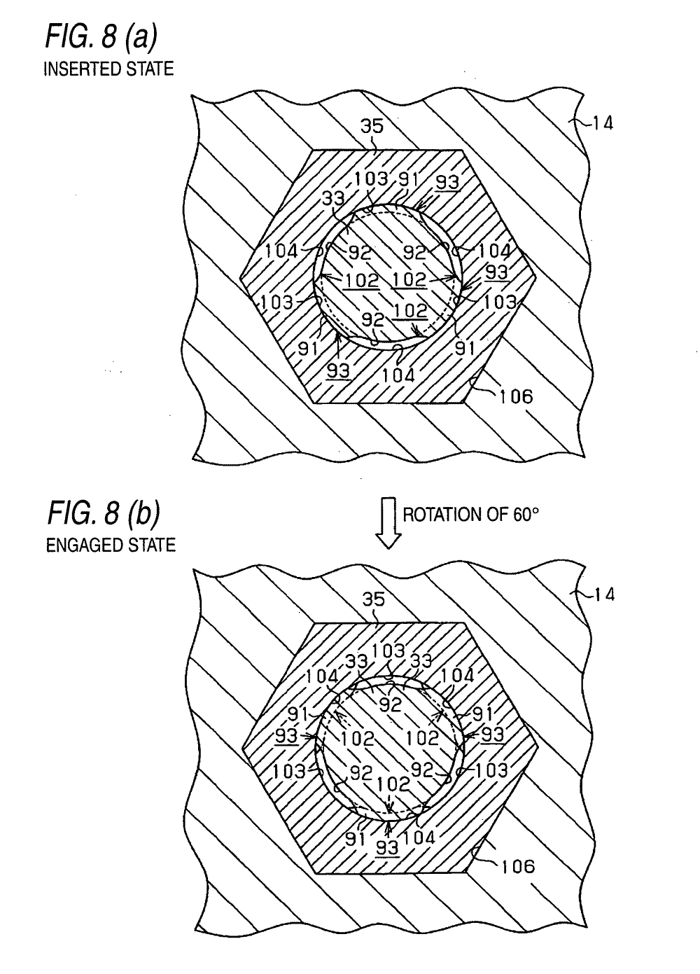

Then, as shown in FIG. 7(a), under a state that the shaft 33 is inserted into the insert hole 101 and an end face of the shaft 33 abuts on the inner bottom surface of the recessed part 106, the engaging crests 91 of the shaft 33 side are located so as to correspond to the engaging grooves 104 of the member 35 to be engaged in the rotating direction of the shaft 33. Further, at this time, as shown in FIG. 8(a), the shaft 33 is held in a state that the engaging crests 91 of the shaft 33 side correspond to the circular arc surfaces 103 of the member 35 to be engaged and the circular arc surfaces 92 of the shaft 33 side correspond to the engaging grooves 104 of the member 35 to be engaged. Then, as described above, since the outer forms of the engaging crests 91 correspond to the inner forms of the engaging grooves 104, when the shaft 33 is rotated, the engaging crests 91 are engaged with the engaging grooves 104 so as to be fitted to the engaging grooves 104 as shown in FIG. 7(b).

In this exemplary embodiment, as described above, the three engaging parts 93 in the shaft 33 side are formed at intervals of 120° in the rotating direction of the shaft 33 and within the range of angle of 60° in the rotating direction of the shaft 33. Further, the three parts 102 to be engaged of the member 35 to be engaged are formed at intervals of 120° in the circumferential direction of the insert hole 101 and within the range of angle of 60° in the circumferential direction of the insert hole 101. Accordingly, in an inserted state that the shaft 33 is inserted into the insert hole 101 as shown in FIG. 7(a), when the shaft 33 is rotated by 60°, the engaging crests 91 in the shaft 33 side are completely fitted to the engaging grooves 104 of the member 35 to be engaged. Namely, as shown in FIG. 8(b), the engaging crests 91 in the shaft 33 side correspond to the engaging grooves 104 in the member 35 to be engaged. In an engaged state of the shaft 33, that is, in a state that the engaging crests 91 correspond to the engaging grooves 104, the displacement of the shaft 33 toward a direction in which the shaft 33 is drawn from the insert hole 101 is regulated due to the engaging relation of the engaging crests 91 and the engaging grooves 104.

The displacement of the shaft 33 toward an inserting direction to the insert hole 101 is regulated due to the abutment of the end face of the shaft 33 on the inner bottom surface of the recessed part 106. Namely, the recessed part 106 (precisely, a part corresponding to the insert hole 101 in its inner bottom surface) serves as an abutting part on which the end face of the shaft 33 abuts.

### <Protruding Length of End Part of Shaft>

As described above, since the end part of the shaft 33 protrudes from the side surface of the movable mold 15 in the fixed mold 14 side, a protruding length is set as described below. Specifically, as shown in FIG. 6(a), under a state that the movable mold 15 is separated from the fixed mold 14 and the end part of the shaft 33 is separated from the fixed mold 14, the protruding length L1 of the shaft 33 to the side surface of the movable mold 15 in the fixed mold 14 side is set to a length longer by a prescribed margin length δ than the depth L2 of the recessed part 106 to the side surface of the fixed mold 14 in the movable mold 15 side.

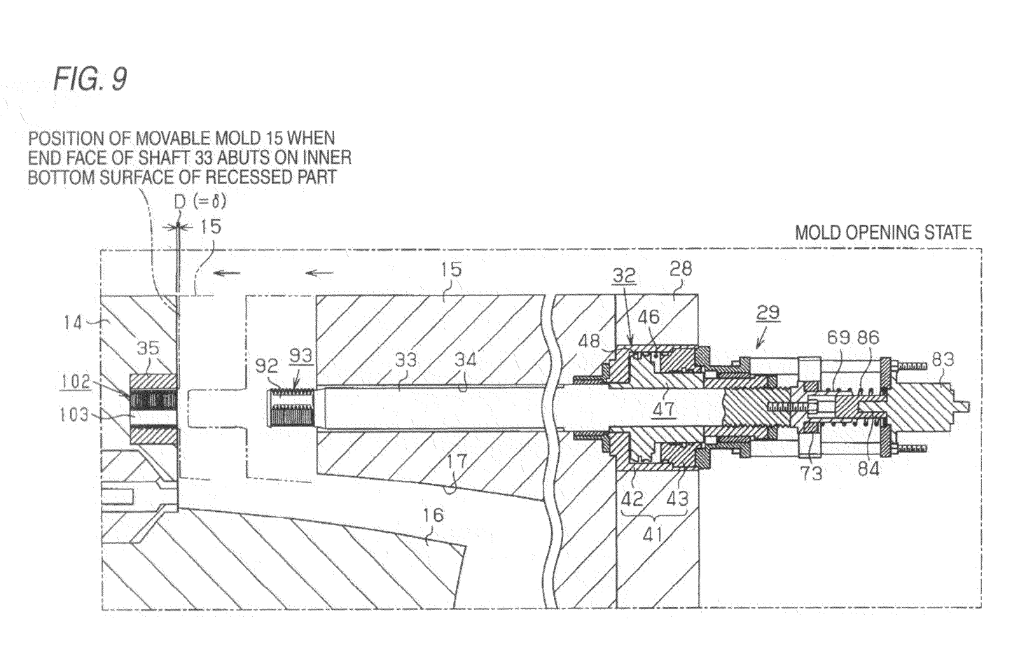

Accordingly, as shown by a two-dot chain line in FIG. 9, under a state that the movable mold 15 is allowed to come near to the fixed mold 14 and the end face of the shaft 33 abuts on the inner bottom surface of the recessed part 106, a gap D having the same distance as the above-described margin length δ is formed between the movable mold 15 and the fixed mold 14. Then, when the movable mold 15 is further allowed to come near to and come into close contact with the fixed mold 14, the shaft 33 is consequently displaced by the same distance as the margin length δ so as to separate from the fixed mold 14 against the resilient force of the compression coil spring 86. Then, at this time, the piston 47 of the hydraulic washer 32 is also displaced integrally with the shaft 33 by the same distance, that is, the margin length δ in the same direction.

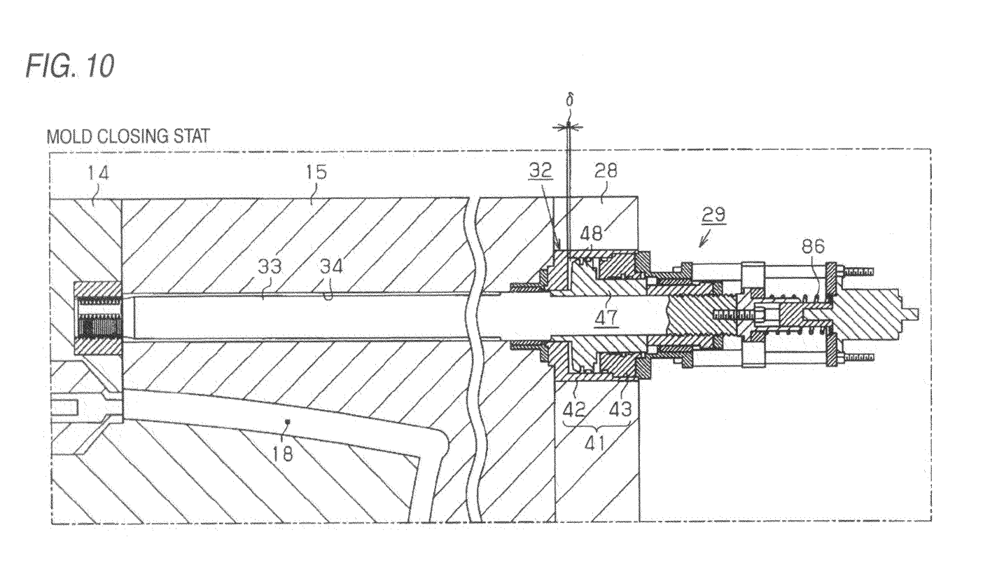

Here, as described above, the shaft 33 and the piston 47 are constantly urged to come near to the inner bottom surface of the cylinder main body 42 by the resilient force of the compression coil spring 86. Therefore, as shown in FIG. 9, under a state that the working fluid is not supplied to the hydraulic chamber 46, the side surface of the piston main body 48 opposite to the cover member 43 is held in an abutting state on the inner bottom surface of the cylinder main body 42. Also as described above, when the movable mold 15 is allowed to come into close contact with the fixed mold 14, the cylinder main body 48 is displaced from the cylinder main body 42 by the same distance as the above-described margin length δ so as to separate from the fixed mold 14. As a result, as shown in FIG. 10, the side surface of the piston main body 48 opposite to the cover member 43 is separated from the inner bottom surface of the cylinder main body 42 by the same distance as the margin length δ. Under this state, the length of the hydraulic chamber 46 in the axial direction and the length of the piston main body 48 in the axial length are set so that a prescribed space is formed between the side surface of the cylinder main body 42 in the cover member 43 side and the inner surface of the cover member 43.

### <Operation of Exemplary Embodiment>

Now, an operation of the mold clamping mechanism constructed as described above will be described in accordance with molding processes by the injection-molding machine.

### <Before Molding Operation>

As shown by a full line in FIG. 9, before a molding operation, the movable mold 15 is maintained under a state that the movable mold 15 is separated from the fixed mold 14. At this time, the end part of the shaft 33 protruding from the side surface of the movable mold 15 in the fixed mold 14 side is also separated from the side surface of the fixed mold 14 in the movable mold 15 side. Further, the shaft 33 is held so that the plurality of engaging parts 93 provided on the end part and the parts 102 to be engaged of the member 35 to be engaged are alternately arranged on their axes. Namely, when the movable mold 15 is moved to come near to the fixed mold 14, the end part of the shaft 33 is smoothly inserted into the insert hole 101 of the member 35 to be engaged (see FIG. 7(a) and FIG. 8(a)).

Further, before the molding operation, the output shaft 84 of the air motor 83 is stopped. Further, since the supply of the working fluid to the hydraulic chamber 46 of the hydraulic washer 32 is stopped, the pressure of the hydraulic chamber 46 is maintained in a lowered level. Here, the piston 47 is constantly urged to separate from the cover member 43 of the hydraulic washer 32 through the stopper 73, the driven shaft 69 and the shaft 33 by the resilient force of the compression coil spring 86. Now, since the pressure of the hydraulic chamber 46 is in the low level, the piston main body 48 is maintained in a state that the piston main body 48 abuts on the inner bottom surface of the cylinder main body 42 of the washer 32 by the resilient force of the compression coil spring 86.

### <Mold Closing Process>

When the molding operation is started, as shown by a two-dot chain line in FIG. 9, the movable mold 15 is moved to come near to the fixed mold 14 by the operation of the opening and closing mechanism 19 (in FIG. 9, an illustration is omitted). Thus, the end part of the shaft 33 protruding from the movable mold 15 is also moved to come near to the fixed mold 14. Then, when the movable mold 15 is further moved to come nearer to the fixed mold 14 by the operation of the opening and closing mechanism 19, the end part of the shaft 33 is inserted into the insert hole 101 of the member 35 to be engaged, and the end face of the shaft 33 abuts on the inner bottom surface of the recessed part 106 formed in the member 35 to be engaged. Under this state, as shown by the two-dot chain line in FIG. 9, the small gap D is formed between the movable mold 15 and the fixed mold 14.

As described above, the protruding length of the shaft 33 to the side surface of the movable mold 15 in the fixed mold 14 side is set to the length longer by the margin length δ than the depth of the recessed part 106 to the side surface of the fixed mold 14 in the movable mold 15 side. Therefore, under the state that the movable mold 15 is allowed to come near to the fixed mold 14 and the end face of the shaft 33 abuts on the inner bottom surface of the recessed part 106, the dimension of the gap D formed between the fixed mold 14 and the movable mold 15 is the same as that of the above-described margin length δ.

Then, when the movable mold 15 is further moved to come nearer to the fixed mold 14 by the operation of the opening and closing mechanism 19, as shown in FIG. 10, the movable mold 15 finally comes into close contact with the fixed mold 14. Thus, the shaft 33 is displaced by the same distance as the margin length δ in the protruding direction to the side surface of the movable plate 28 opposite to the movable mold 15 against the resilient force of the compression coil spring 86. Then, at this time, the piston 47 of the hydraulic washer 32 is displaced by the same distance. That is, the margin length δ in the same direction integrally with the shaft 33. As a result, the piston main body 48 is separated by the above-described margin length δ from the inner bottom surface of the cylinder main body 42.

As shown in FIG. 10, in a mold closing state that the movable mold 15 comes into contact with the fixed mold 14, the operation of the opening and closing mechanism 19 is stopped. Under this state, the cavity 18 is formed between the fixed mold 14 and the movable mold 15.

### <Mold Clamping Process>

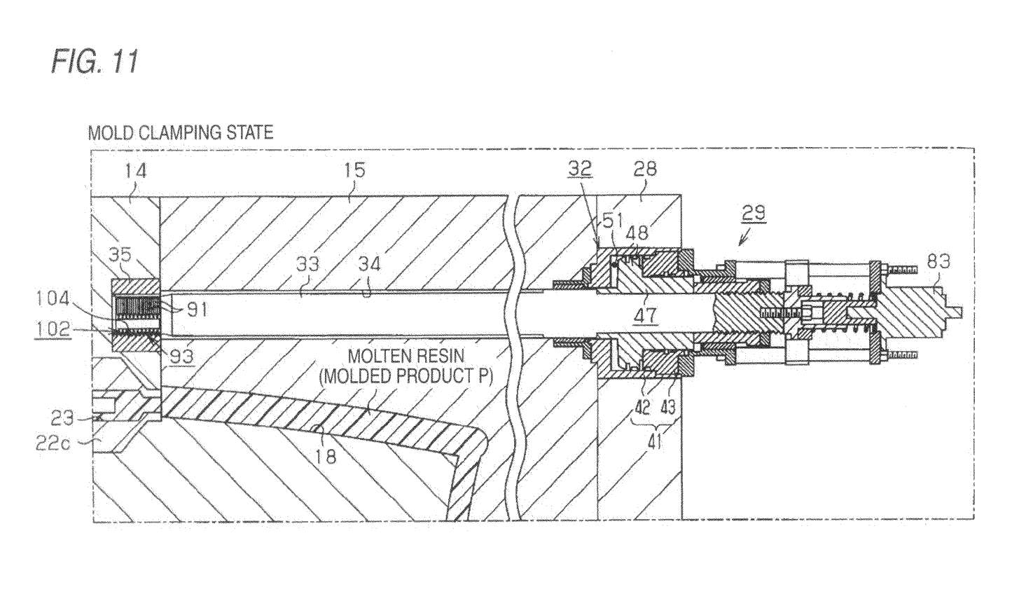

Then, as shown in FIG. 11, when the shaft 33 is rotated by a prescribed rotating angle (here, 60°) through the operation of the air motor 83. Thus, the engaging parts 93 provided in the end part of the shaft 33 are engaged with the parts 102 to be engaged of the member 35 to be engaged. Namely, under the state that the shaft 33 is inserted into the insert hole 101 as shown in FIG. 7(a) and FIG. 8(a), when the shaft 33 is rotated by 60°, the engaging crests 91 of the shaft 33 side are completely fitted to the engaging grooves 104 in the member 35 side to be engaged. Specifically, as shown in FIG. 7(b) and FIG. 8(b), the engaging crests 91 of the shaft 33 side are held in an engaging state in which the engaging crests 91 of the shaft 33 side correspond to the engaging grooves 104 of the member 35 to be engaged and are engaged with the engaging grooves 104.

In according with the engaging relation between the engaging crests 91 and the engaging grooves 104, the displacement of the shaft 33 toward a direction for drawing the shaft from the insert hole 101 is regulated. That is, the end part of the shaft 33 is connected to the fixed mold 14.

Then, the movable mold 15 is further pressed to the fixed mold 14 to clamp the molds. Namely, as shown in FIG. 11, the working fluid of the high pressure is supplied to the mold clamping hydraulic chamber 51 of the hydraulic washer 32 through the sprue runner not shown in the drawing that is provided in the cylinder main body 42 and the movable plate 28. Then, the hydraulic pressure of the working fluid is applied to the side surface of the piston main body 48 in the mold clamping hydraulic chamber 51 side so that the piston 47 is displaced integrally with the shaft 33 toward the cover member 43 side. Accordingly, the shaft 33 is pulled toward a drawing direction relative to the fixed mold 14 and slightly elongates. As a result, in the shaft 33, tensile force for returning the shaft to an original state against the elongation, that is, an axial force is generated. The movable mold 15 is pressed to the fixed mold 14 by the axial force generated in the shaft 33 to clamp the molds. As described above, the hydraulic washer 32 functions as an axial force generating unit for generating the axial force in the shaft 33.

In accordance with the specification of the injection-molding machine 11, the pressure of the working fluid supplied to the mold clamping hydraulic chamber 51 is set so as to generate the axial force of a sufficient level necessary for clamping the molds. Further, the working fluid is supplied to the mold clamping chamber 51 so that a large power directed toward the drawing direction relative to the fixed mold 14 is applied to the shaft 33. However, as described above, in accordance with the engaging relation of the engaging parts 93 of the shaft 33 and the parts 102 to be engaged of the member 35 to be engaged, the displacement of the shaft 33 toward the drawing direction relative to the fixed mold 14 is regulated. Namely, the shaft 33 is held in a state that the shaft 33 is fixed to the fixed mold 14 in its end part. Thus, the sufficient axial force is generated in the shaft 33. The supply of the working fluid to the mold clamping hydraulic chamber 51, that is, the high hydraulic pressure state is maintained until the molten resin is cooled and solidified after the cavity 18 is filled with the molten resin.

### <Injection Process>

Then, the molten resin is injected under high pressure from the nozzle 25 of the injection device 24. The molten resin injected from the nozzle 25 is supplied to the inner part of the cavity 18 through the sprue 23. As shown in FIG. 11, the inner part of the cavity 18 is filled with the molten resin. At this time, since the movable mold 15 is pressed to the fixed mold 14 by the mold clamping mechanisms 29 respectively, the movable mold 15 is not separated from the fixed mold 14 by the injection pressure of the molten resin. Then, the molten resin with which the inner part of the cavity b18 is filled is cooled and solidified via cooling and solidifying processes to form a desired molded product P in the inner part of the cavity 18.

### <Mold Opening Process>

After the formation of the molded product (P) is completed, the movable mold 15 is separated from the fixed mold 14 to take out the molded product. At this time, as shown in FIG. 11, initially, the above-described mold clamping state is released. Namely, in the hydraulic washer 32, the supply of the working fluid to the mold clamping hydraulic chamber 51 is stopped and the working fluid in the mold clamping hydraulic chamber 51 is discharged to an external part through a discharge path not shown in the drawing. Thus, the hydraulic pressure of the mold clamping hydraulic chamber 51 is lowered. Then, the shaft 33 that elongates due to the displacement of the piston 47 toward the direction of separating from the inner bottom surface of the cylinder main body 42 by the hydraulic pressure of the mold clamping hydraulic chamber 51 contracts by its elasticity. Accordingly, the piston 47 is displaced in the direction of coming near to the inner bottom surface of the cylinder main body 42 to be held in a position shown in FIG. 10. Namely, gaps are formed between the piston main body 48 and the inner bottom surface of the cylinder main body 42 and between the piston main body 48 and the cover member 43. Further, in accordance with the contraction of the shaft 33, the axial force of the shaft 33 by the hydraulic washer 32 is reduced.

Then, the engaged state of the shaft 33 and the fixed mold 14 is released. That is, the shaft 33 is rotated by a prescribed rotating angle (here, 60°) in the opposite direction to the rotating direction in the above-described mold clamping process through the operation of the air motor 83. Then, the engagement of the engaging part 93 of the shaft 33 and the parts 102 to be engaged of the member 35 to be engaged is released (see FIG. 10). Thus, the movable mold 15 can be moved so as to be separated from the fixed mold 14.

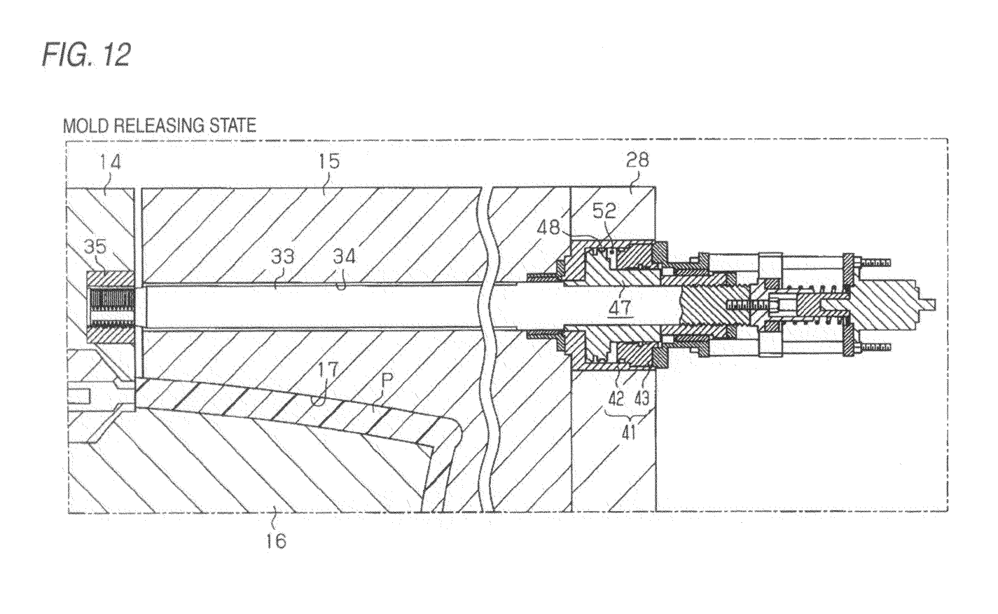

Subsequently, as shown in FIG. 12, to the mold releasing hydraulic chamber 52 of the hydraulic washer 32, the working fluid of the high pressure is supplied through the sprue runner not shown in the drawing that is provided in the cylinder main body 42 and the movable plate 28. Then, the hydraulic pressure of the working fluid is applied to the side surface of the piston main body 48 in the mold releasing hydraulic chamber 52 side, so that the piston 47 is displaced integrally with the shaft 33 toward the direction so as to come near to the inner bottom surface of the cylinder main body 42 (the direction for separating the piston main body from the cover member 43). Thus, the shaft 33 is compressed to apply a force to the movable mold 15 in the direction for separating the movable mold 15 from the fixed mold 14.

Namely, although the shaft 33 tries to be displaced in the direction protruding relative to the side surface of the movable mold 15 in the fixed mold 14 side in accordance with the displacement of the piston 47 in the direction for separating the piston 47 from the cover member 43, since the end face of the shaft 33 abuts on the inner bottom surface of the recessed part 106, the displacement is regulated. Accordingly, on the inner bottom surface of the recessed part 106, a repulsive force acts by which the compressed shaft 33 tries to return to an original state. Further, an amount of displacement of the shaft 33 in its moving direction is regulated within a prescribed range relative to the movable mold 15. In other words, the shaft 33 is provided so as to be displaced between a position where the piston main body 48 abuts on the inner bottom surface of the cylinder main body 42 and a position where the piston main body 48 abuts on the cover member 43. Therefore, the repulsive force by which the compressed shaft 33 tries to return to the original state acts on the movable mold 15 as a force (a mold releasing force) for separating the movable mold 15 from the fixed mold 14. As a result, as shown in FIG. 12, the movable mold 15 is slightly separated, precisely, by the displacement of the piston 47 toward the inner bottom surface side of the cylinder main body 42 (the above-described margin length δ) from the fixed mold 14. As described above, the mold clamping mechanism 29 also functions as a mold releasing mechanism for separating the movable mold 15 pressed to the fixed mold 14 as a mold releasing mechanism.

In a mold releasing operation for separating the movable mold 15 from the fixed mold 14, the pressure of the working fluid supplied to the mold releasing hydraulic chamber 52 is set so as to generate the axial force of a sufficient level necessary for the mold releasing operation in the shaft 33. More specifically, in the injection-molding machine 11 of the present exemplary embodiment, the movable mold 15 is pressed to the fixed mold 14 by the mold clamping mechanisms 29 respectively to clamp the molds by an extremely large clamping force. When the movable mold 15 is separated from the fixed mold 14 to open the molds, during a first period of the mold opening operation, a large force, which is not so large as that necessary during the above-described mold clamping operation, (for instance, a force about 1/10 times as large as the force necessary for the mold clamping operation) is necessary. The large force is necessary because of, for instance, below-described reasons (I) and (II).

(I) During the mold clamping operation, the movable mold 15 is deformed and allowed to come into close contact with the fixed mold 14 so that the molten resin does not flow into other part than the cavity 18 between the fixed mold 14 and the movable mold 15. Accordingly, during the mold opening operation, the movable mold 15 that is deformed and comes into close contact with the fixed mold 14 needs to be moved. Accordingly, the large force is necessary.

(II) Since the movable mold 15 comes into contact with a synthetic resin (the molded product P) which is supplied to the cavity 18, cooled and solidified, the movable mold 15 needs to be peeled off from the molded product P during the first period of the mold opening operation. Thus, the large force is necessary for that purpose.

Then, the pressure of the working fluid supplied to the mold releasing hydraulic chamber 52 is set so as to generate the large force required as described above for opening the molds, that is, the mold releasing force.

As described above, under the state that the movable mold 15 is slightly separated from the fixed mold 14, then, the movable mold 15 is greatly moved so as to be separated from the fixed mold 14 through the operation of the opening and closing mechanism 19. As described above, the shaft 33 is constantly urged to protrude from side surface of the movable mold 15 in the fixed mold 14 side by the resilient force of the compression coil spring 86. Accordingly, as the movable mold 15 is gradually separated from the fixed mold 14, the shaft 33 gradually protrudes from the side surface of the movable mold 15 in the fixed mold 14 side. The displacement of the shaft 33 toward the direction protruding from the side surface of the movable mold 15 in the fixed mold 14 side is regulated due to the abutment of the piston 47 on the inner bottom surface of the cylinder main body 42. Namely, the contact state of the end face of the shaft 33 and the inner bottom surface of the recessed part 106 is maintained until the piston 47 abuts on the inner bottom surface of the cylinder main body 42 after the movable mold 15 is moved to be separated from the fixed mold 14.

Then, when the end part of the shaft 33 is separated relative to the fixed mold 14 and the movable mold 15 is separated relative to the fixed mold 14 to a mold opening position determined as a position where the molded product P is taken out, the operation of the opening and closing mechanism 19 is stopped. In accordance with the above-described operations, a mold opening process is completed. When the movable mold 15 is separated from the fixed mold 14, the molded product P is peeled off from the molding recessed part 17 of the movable mold 15 and held in close contact with the molding protrusion 16 of the fixed mold 14. This process is carried out, because the molded product P shrinks and is apt to stick to the molding protrusion 16 side in accordance with the above-described cooling and solidifying processes.

### <Taking-Out Process of Molded Product>

Then, the molded product P that comes into close contact with the molding protrusion 16 of the fixed mold 14 is taken out. Namely, the molded product P in close contact with the molding protrusion 16 is ejected to be separated from the molding protrusion 16 by the operation of the ejector mechanism 27 (see FIG. 1). Thus, the molded product P is peeled off from the molding protrusion 16 and taken out between the fixed mold 14 and the movable mold 15. In accordance with the above-described processes, the molding cycle of the molded product P is completed once.

### <Advantages of Exemplary Embodiment>

Thus, according to the present exemplary embodiment, below-described advantages can be obtained.

(1) In the resin molding, when the movable mold 15 is allowed to come into contact with the fixed mold 14, as the movable mold 15 gradually comes into contact with the fixed mold 14, the engaging parts 93 formed in the end part of the shaft 33 are inserted into the inserting hole 101 provided in the fixed mold 14 side. Then, under this state, when the shaft 33 is rotated by the predetermined rotating angle through the operation of the air motor 83, the engaging parts 93 of the shaft 33 are engaged with the parts 102 to be engaged which are formed on the inner peripheral surface of the insert hole 101. Thus, the displacement of the shaft 33 toward the direction for drawing the shaft from the inserting hole 101 is regulated. Then, under this state, when the working fluid is supplied to the mold clamping hydraulic chamber 51 of the hydraulic washer 32 to apply the force to the shaft 33 for drawing the shaft 33 from the insert hole 101, the shaft 33 elongates in the axial direction. As a result, in the shaft 33, the tensile force for returning the shaft to the original state against the elongation, that is, the axial force is generated. The movable mold 15 is pressed to the fixed mold 14 by the axial force generated in the shaft 33 to clamp the molds.

As described above, under the state that the end part of the shaft 33 is connected to the fixed mold 14, the shaft 33 is urged to separate from the fixed mold 14 through the operation of the hydraulic washer 32, so that the movable mold 15 is directly pressed to the fixed mold 14. As described above, usually, the mold clamping mechanism is known in which in order to press the movable mold to the fixed mold, the fixed die plate to which the fixed mold is attached and the movable die plate to which the movable mold is attached are provided separately from the molds, and the ball screw passing through and supported by the movable die plate is screwed to the fixed die plate to press the movable mold to the fixed mold. In the mold clamping mechanism 29 according to the present exemplary embodiment, since the movable mold is directly pressed to the fixed mold without using the fixed die plate and the movable die plate, which is different from the usual mold clamping mechanism, the fixed die plate and the movable die plate can be saved so that the mold clamping mechanism may be the more compact.

Further, as already described above, usually, the mold clamping mechanism is also known in which under the state that the movable mold is allowed to come into contact with the fixed mold, the end part (the end part in the fixed mold side) of the bolt passing through the movable mold is screwed to the female screw part of the fixed mold side to generate the axial force in the shaft part of the bolt so that the movable mold is pressed to the fixed mold. In the mold clamping mechanism 29 of the present exemplary embodiment, when the shaft 33 is connected to the fixed mold 14, since the shaft does not need to take a plurality of turns, which is different from the usual mold clamping mechanism, the mold clamping operation is the simpler. Further, in the usual mold clamping mechanism, when the movable mold is separated from the fixed mold, the bolt needs to take a plurality of turns in the direction for unfastening the bolt to release the fixed state of the bolt to the fixed mold. However, according to the present exemplary embodiment, such an operation is not necessary. Therefore, the mold clamping operation and the operation for releasing the mold clamping operation can be carried out at high speed.

Accordingly, the mold clamping mechanism uses the structure eliminating the die plate for clamping the mold to realize the compact structure and can improve the molding cycle of a resin molded product by carrying out the mold clamping operation and the operation for releasing the mold clamping operation at higher speed.

(2) When the working fluid is supplied to the mold releasing hydraulic chamber 52 of the hydraulic washer 32 to apply the force directed toward the fixed mold 14 side to the shaft 33, the shaft 33 is liable to be displaced toward the fixed mold 14 side. However, under the state that the movable mold 15 comes into contact with the fixed mold 14, the end face of the shaft 33 in the fixed mold 14 side is kept in a state that the end face abuts on the inner bottom surface of the recessed part 106. Thus, the displacement of the shaft 33 toward the fixed mold 14 side is regulated due to the abutment of the end face of the shaft 33 in the fixed mold 14 side on the inner bottom surface of the recessed part 106. Accordingly, the shaft 33 is compressed by the force directed toward the fixed mold 14 side applied through the operation of the hydraulic washer 32. Then, in the shaft 33, the repulsive force is generated for returning the shaft to its original state. Here, since the shaft 33 is supported under the state that the amount of displacement of the shaft 33 in its moving direction is regulated within a prescribed range relative to the movable mold 15. Namely, the shaft 33 is supported under a state that the shaft 33 is inserted into the piston 47 provided in the cylinder 41 fixed to the movable mold 15. Thus, the repulsive force generated in the shaft 33 is applied on the movable mold 15 as the force in the direction for separating the movable mold from the fixed mold 14. As a result, when the force directed toward the fixed mold 14 side is applied to the shaft 33 through the operation of the hydraulic washer 32, the movable mold 15 is separated from the fixed mold 14 by the same distance as the distance by which the shaft 33 is naturally displaced toward the fixed mold 14 side. In such a way, the mold clamping mechanism 29 also functions as a mold releasing mechanism for separating the movable mold 15 from the fixed mold 14. Thus, the structure of the injection-molding machine 11 is simplified differently from a case that the mold releasing mechanism is separately provided. Further, the mold clamping operation, the releasing operation of the mold clamping operation and the mold releasing operation can be continuously carried out through the mold clamping mechanism 29, which contributes to the shortening of the molding cycle of the resin molded product.

(3) When the movable mold 15 is pressed to the fixed mold 14, under the state that the engaging parts 93 of the shaft 33 are engaged with the parts 102 to be engaged in the fixed mold 14 side through the operation of the air motor 83, the working fluid is supplied to the mold clamping hydraulic chamber 51 in the cylinder 41. The pressure of the working fluid acts on the piston 47 in the direction for separating the piston from the fixed mold 14. Then, since the piston 47 is externally fitted and fixed to the shaft 33, the force in the direction opposite to the fixed mold 14 is applied to the shaft 33 through the piston 47. On the other hand, when the movable mold 15 pressed to the fixed mold 14 is separated from the fixed mold 14, under the state that the engaged state of the engaging parts 93 of the shaft 33 with the parts 102 to be engaged in the fixed mold 14 side is released through the operation of the air motor 83, the working fluid is supplied to the mold releasing hydraulic chamber 52 in the cylinder 41. Thus, the force directed toward the fixed mold 14 side is applied to the shaft 33 through the piston 14. As described above, when the mold clamping operation for pressing the movable mold 15 to the fixed mold 14 or the mold releasing operation for separating the movable mold 15 pressed to the fixed mold 14 from the fixed mold 14 is carried out, the working fluid is merely supplied to the mold clamping hydraulic chamber 51 or the mold releasing hydraulic chamber 52 in the cylinder 41, so that the force in the opposite direction to the fixed mold 14 or in the direction toward the fixed mold 14 side may be applied to the shaft 33 to generate the prescribed axial force. Namely, the two forces directed in the opposite directions to each other may be properly applied to the shaft 33 by a simple structure such as the cylinder 41 and the piston 47. Since the hydraulic washer 32 as described above is employed, the structure of the mold clamping mechanism 29 is not complicated and the mold clamping mechanism may also function as the mold releasing mechanism.

(4) In the mold clamping operation, as the movable mold 15 is allowed to gradually come into contact with the fixed mold 14, the shaft 33 is inserted into the insert hole 101 in the fixed mold 14 side in such a holding state as to arrange alternately the plurality of engaging parts 93 and the parts 102 to be engaged of the fixed mold 14 side in its rotating direction. In other words, in the positional relation that the engaging parts 93 of the shaft 33 side and the parts 102 to be engaged in the fixed mold 14 side are alternately arranged, when the shaft 33 is inserted into the insert hole 101, the plurality of engaging crests 91 forming the engaging parts 93 in the shaft 33 side do not interfere with the plurality of engaging grooves 104 forming the parts 102 to be engaged in the fixed mold 14 side. Thus, the shaft 33 can be smoothly inserted into the insert hole 101. Then, under the state that the engaging parts 93 of the shaft 33 are inserted into the insert hole 101 of the fixed mold 14 side, the shaft 33 is rotated by an angle (in the present exemplary embodiment, 60°) half the interval for forming the engaging part 93 as the predetermined rotating angle through the operation of the air motor 83 so that the engaging crests 91 forming the engaging parts 93 are respectively engaged with the engaging grooves 104 respectively forming the parts 102 to be engaged. Thus, the displacement of the shaft 33 in the direction opposite to the fixed mold 104 is regulated. In such a way, as the movable mold 15 gradually comes into contact with the fixed mold 14, the shaft 33 is inserted into the insert hole 101 in the fixed mold 14 side. Further, the shaft 33 can be connected to the fixed mold 14 only by slightly rotating the inserted shaft 33. After that, the force in the direction opposite to the fixed mold 14 is applied to the shaft 33 through the operation of the hydraulic washer 32 to press the movable mold 15 to the fixed mold 14. Accordingly, in the mold clamping operation, a connecting operation of the shaft 33 to the fixed mold 14 is carried out more rapidly than, for instance, a case that the shaft 33 is screwed into the fixed mold 14 until the shaft reaches to a prescribed depth. Thus, the mold clamping operation is carried out at high speed.

Further, in the mold releasing operation, the connected state of the shaft 33 and the fixed mold 14 is released only by slightly rotating the shaft 33 in the direction opposite to that in the case of the mold clamping operation. Specifically, since the engaging parts 93 of the shaft 33 side and the parts 102 to be engaged in the fixed mold 14 side are alternately arranged, the shaft 33 can be drawn from the insert hole 101 of the fixed mold 14 side, and accordingly, the movable mold 15 can be moved in the direction for separating the movable mold from the fixed mold 14. Accordingly, in the mold releasing operation for separating the movable mold 15 from the fixed mold 14, a releasing operation of the connection of the shaft 33 to the fixed mold 14 is carried out more rapidly than the case that in the mold clamping operation, the shaft 33 is screwed into the fixed mold 14 until the shaft reaches to a prescribed depth as described above. Thus, the molding cycle of the injection-molding machine 11 is shortened.

(5) When the air motor 83 is employed that has the output shaft 84 rotating in accordance with the pressure of the compressed air supplied from an external part as the actuator for applying a rotating force or torque to the shaft 33, the air motor 83 may be made to be compact.

In the mold clamping mechanism 29 of the present exemplary embodiment, a large output torque does not need to be applied to the shaft 33 differently from, for instance, the case that the shaft 33 is screwed into the fixed mold 14 to press the movable mold 15 to the fixed mold 14. Namely, the shaft 33 is rotated only when the engaging parts 93 thereof are engaged with the parts 102 to be engaged in the fixed mold 14 side, or when the engaged state of the engaging parts 93 and the parts 102 to be engaged is released. When the mold clamping operation or the mold releasing operation is carried out, the shaft 33 is not rotated in order to generate the large axial force in the shaft 33. Therefore, the output torque required for the air motor 83 is low, so that a more compact air motor may be employed.

<Other Embodiment>

The present exemplary embodiment may be changed and embodied in such a manner as described below.

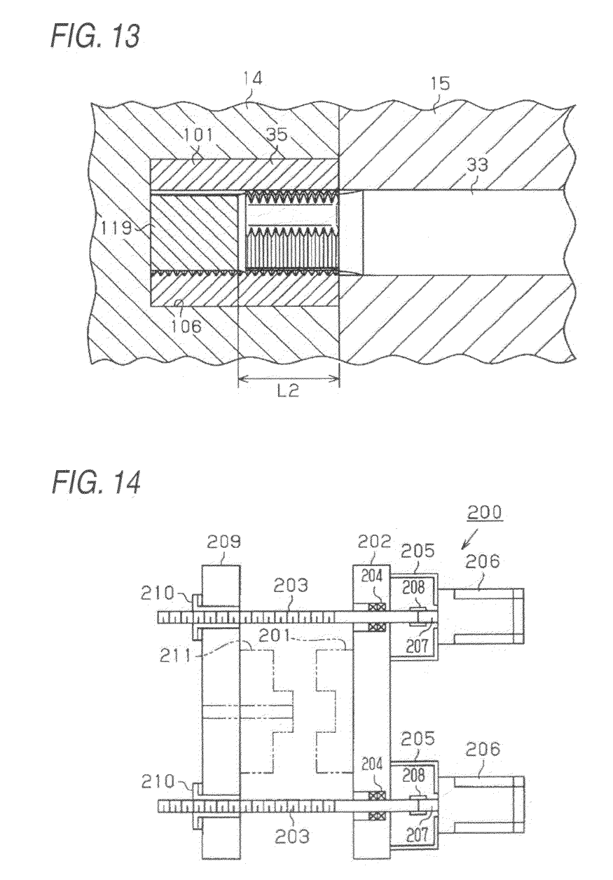

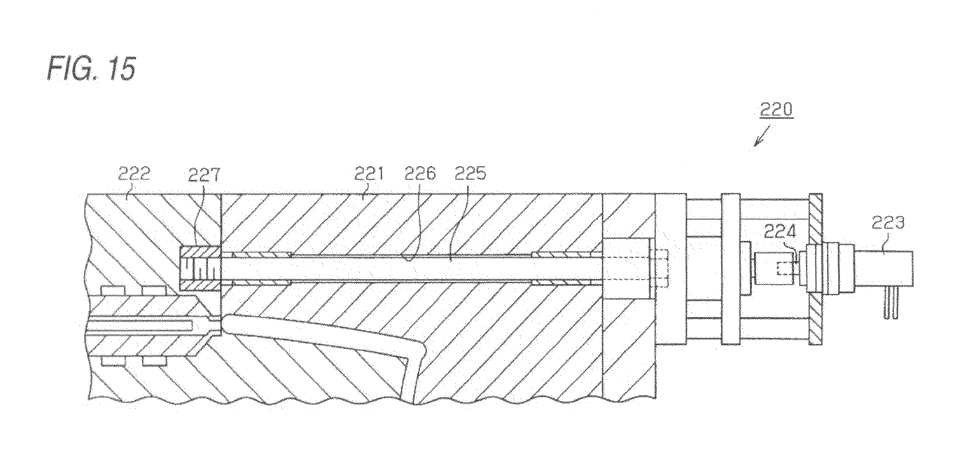

As described in FIG. 13, a spacer 119 may be provided in an insert hole 101 of a member 35 to be engaged to adjust the depth of insertion of a shaft 33 relative to the insert hole 101. In this case, the spacer 119 (precisely, a side surface opposite to the inner bottom surface of a recessed part 106) functions as an abutting part on which the end part of the shaft 33 abuts.

In the present exemplary embodiment, as the actuator for applying the rotating force or the torque to the shaft 33, the air motor is employed. However, a hydraulic pressure motor using other fluid pressure such as hydraulic pressure may be employed. Further, an electric motor may be used.

In the present exemplary embodiment, the member 35 to be engaged is incorporated in the fixed mold 14 as a separate member. However, in the side surface of the fixed mold 14 in the movable mold 15 side, a hole corresponding to the insert hole 101 may be formed and the parts 102 to be engaged may be formed in the inner peripheral surface of the hole. In such a way, the number of parts may be reduced the more for the member 35 to be engaged.

In the present exemplary embodiment, the piston main body 48 is displaced between the position where the piston main body 48 abuts on the inner bottom surface of the cylinder main body 42 and the position where the piston main body 48 abuts on the cover member 43. However, the piston main body 48 may be provided so as not to abut on the inner bottom surface of the cylinder main body 42 and the cover member 43. Namely, a prescribed axial force may be generated on the shaft 33 through the piston 47 in accordance with the pressure of the working fluid supplied to the hydraulic chamber 46 (the mold clamping hydraulic chamber 51 and the mold releasing hydraulic chamber 52).

In the present exemplary embodiment, the horizontal injection-molding machine is embodied in which the molds are opened and closed in the direction along a surface on which the injection-molding machine 11 is installed. However, a vertical injection-molding machine may be embodied in which molds are opened and closed in the vertical direction to the surface of installation. As compared with the horizontal injection-molding machine, the vertical injection-molding machine has advantages that a space may be saved and automation may be easily realized.

In the mold clamping mechanism 29, a function as a mold releasing mechanism may be omitted. In this case, any other mold releasing mechanism may be provided separately from the mold clamping mechanism 29. Even in this case, at least a mold clamping operation and a releasing operation of the mold clamping operation may be carried out at high speed.

What is claimed is:

1. A mold clamping mechanism applied to an injection-molding machine that injects a molten resin into a space part formed between a fixed mold and a movable mold which is allowed to come into contact with and separate from the fixed mold when the movable mold is allowed to come into contact with the fixed mold to form a molded product, and pressing to the fixed mold the movable mold that is allowed to come into contact with the fixed mold in a resin molding, the mold clamping mechanism comprising:
a shaft passing through the movable mold in its moving direction;
a first actuator operatively connected to the shaft to apply a rotating force to the shaft; and
a second actuator operatively connected to the shaft to apply a force in an opposite direction to the fixed mold to the shaft, wherein in an end part of the shaft in the fixed mold side, an engaging part is provided that is inserted into an inserting part provided in the fixed mold side as the movable mold is allowed to gradually come into contact with the fixed mold and is engaged with a part to be engaged which is provided in the inserting part when the shaft is rotated by a predetermined rotating angle through the operation of the first actuator under a state that the engaging part is inserted into the inserting part to regulate a displacement of the shaft in the opposite direction to the fixed mold, and under a state that the engaging part is engaged with the part to be engaged, the force is applied to the shaft in the opposite direction to the fixed mold through the operation of the second actuator to press the movable mold to the fixed mold.

2. The mold clamping machine according to claim 1, wherein the shaft is supported under a state that an amount of displacement of the shaft in its moving direction relative to the movable mold is regulated within a prescribed range, further, in the inserting part, an abutting part is provided on which an end face of the shaft in the fixed mold side abuts under the state that the movable mold is allowed to come into contact with the fixed mold, further, the second actuator may apply a force directed toward the fixed mold side to the shaft, and under a state that the application of the force toward the direction opposite to the fixed mold to the shaft through the operation of the second actuator is released and the engagement of the engaging part of the shaft with the part to be engaged of the inserting part side through the operation of the first actuator is released, the force directed toward the fixed mold side is applied to the shaft through the operation of the second actuator to separate the movable from the fixed mold.

3. The mold clamping machine according to claim 2, wherein the second actuator includes a cylinder fixed to the movable mold and a piston externally fitted and fixed to the shaft, accommodated in an inner part of the cylinder and displaced within a prescribed range along the moving direction of the movable mold relative to the cylinder, under the state that the movable mold is allowed to contact with the fixed mold, a mold clamping fluid pressure or hydraulic pressure chamber is defined and formed in the fixed mold side of the piston in the cylinder and a mold releasing fluid pressure or hydraulic pressure chamber is defined and formed in a side of the piston opposite to the fixed mold by the piston, and when the force is applied to the shaft in the direction opposite to the fixed mold, a working fluid is supplied to the mold claming fluid pressure or hydraulic pressure chamber and when the force directed toward the fixed mold side is applied to the shaft, the working fluid is supplied to the mold releasing fluid pressure or hydraulic pressure chamber.

4. The mold clamping mechanism according to claim 1, wherein the engaging part of the shaft includes a plurality of engaging crests formed at prescribed intervals in its circumferential direction on an outer peripheral surface of the end part of the shaft in the fixed mold side and formed with a prescribed length at prescribed intervals in the axial direction of the shaft and along the circumferential direction of the shaft, the inserting part is formed in the fixed mold as an inserting hole corresponding to the outer form of the end part of the shaft in the fixed mold side, the part to be engaged of the inserting part includes a plurality of engaging grooves formed at the same intervals as those of the engaging part of the shaft side in its circumferential direction on an inner peripheral surface of the inserting part and formed with a prescribed length at prescribed intervals in the axial direction of the inserting part and along the circumferential direction of the inserting part, the shaft is inserted into the inserting part in such a holding state as to arrange alternately the plurality of engaging parts and the parts to be engaged of the inserting part side in its rotating direction and under the state that the shaft is inserted into the inserting part, the shaft is rotated by an angle half the interval for forming the engaging part as the predetermined rotating angle through the operation of the first actuator so that the engaging crests forming the engaging part are respectively engaged with the engaging grooves respectively forming the part to be engaged to regulate the displacement of the shaft in the direction opposite to the fixed mold.

5. The mold clamping mechanism according to claim 1, wherein the first actuator is a hydraulic pressure motor having an output shaft rotating in accordance with the hydraulic pressure of the working fluid supplied from an external part.

6. An injection-molding machine that forms a space part between a fixed mold and a movable mold which is allowed to come into contact with or separate from the fixed mold by allowing the movable mold to come into contact with the fixed mold, presses the movable mold to the fixed mold to clamp the mold through the operation of a mold clamping mechanism and injects a molten resin into the space part under a mold clamped state to form a molded product, the injection-molding machine including the mold clamping mechanism according to claim 1 as the mold clamping mechanism.
